(19) United States
(12) Patent Application Publication
(10) Pub. No.: US 2017/0361188 A1
(43) Pub. Date: Dec. 21, 2017

(54) BASEBALL GAME SYSTEM

(71) Applicant: CLOUDGATE CORP., Seoul (KR)

(72) Inventor: Soonmok JANG, Namyangju-si (KR)

(21) Appl. No.: 15/622,695

(22) Filed: Jun. 14, 2017

(30) Foreign Application Priority Data
Jun. 15, 2016 (KR) 10-2016-0074300

(51) Int. Cl. A63B 69/00; A63B 71/06; G06T 7/73; A63B 69/40

(52) U.S. Cl. CPC A63B 69/0002; A63B 69/40; A63B 71/0622; G06T 7/73; A63B 2220/807; A63B 2069/401; G06T 2207/10004; G06T 2207/30224; G06T 2207/30241; A63B 2071/0638

(57) ABSTRACT

A baseball game system is capable of accurately determining a location of a ball using a single camera, the baseball game system including: a pitching unit pitching a ball toward a determination area including a strike zone; a photographing unit positioned in a space between the determination area and the pitching unit; and a location detector detecting a location of a ball based on a plurality of images from the photographing unit. The location detector includes a non-stroke processor detecting a location of a non-struck ball and a stroke processor detecting a location of a struck ball. The non-stroke processor sets first, second, third and fourth straight lines defining the strike zone; calculates, when the ball in the image passes between the first straight line and the second straight line, an average size of the balls between the first straight line and the second straight line; and detects a vertical location of the ball in the determination area based on the average size.

### CROSS-REFERENCE TO RELATED APPLICATION

This application claims priority under 35 U.S.C. §119 to Korean Patent Application No. 10-2016-0074300, filed on Jun. 15, 2016, in the Korean Intellectual Property Office (KIPO), the disclosure of which is incorporated by reference herein in its entirety.

### 1. TECHNICAL FIELD

Embodiments of the present invention relate to a baseball game system, and more particularly, to a baseball game system capable of accurately determining a location of a ball using a single camera.

### 2. DISCUSSION OF RELATED ART

A conventional baseball system determines an accurate location of a ball in a determination area by photographing the ball at various angles using a plurality of cameras. Since the conventional baseball system requires the plurality of cameras, it costs a lot to implement the system.

It is to be understood that this background of the technology section is intend portioned to provide useful background for understanding the technology and as such disclosed herein, the technology background section may include ideas, concepts or recognitions that were not part of what was known or appreciated by those skilled in the pertinent art prior to a corresponding effective filing date of subject matter disclosed herein.

### SUMMARY

Exemplary embodiments of the present invention may be directed to a baseball game system capable of accurately determining a location of a ball using a single camera.

According to an exemplary embodiment, a baseball game system includes: a pitching unit pitching a ball toward a determination area including a strike zone; a photographing unit positioned in a space between the determination area and the pitching unit; and a location detector detecting a location of a ball based on a plurality of images from the photographing unit. The location detector includes a non-stroke processor detecting a location of a non-struck ball and a stroke processor detecting a location of a struck ball. The non-stroke processor sets first, second, third and fourth straight lines defining the strike zone; calculates, when the ball in the image passes between the first straight line and the second straight line, an average size of the balls between the first straight line and the second straight line; and detects a vertical location of the ball in the determination area based on the average size.

The strike zone defined by the first, second, third and fourth straight lines may have a trapezoidal shape.

The non-stroke processor may detect the vertical location of the ball in the determination area by comparing the average size with a predetermined reference value.

The reference value may include a lower limit value defining a size of the ball located at a lower side of the strike zone; and an upper limit value defining a size of the ball located at an upper side of the strike zone.

The non-stroke processor may calculate coordinates of a first point representing a vertical location of the ball on the third straight line based on the comparison between the average size and the reference value; calculate coordinates of a second point representing a vertical location of the ball on the fourth straight line based on the comparison between the average size and the reference value; and set a fifth straight line passing through the first point and the second point.

The non-stroke processor may set a sixth straight line based on a trajectory of the ball and calculate a horizontal location of the ball in the determination area based on coordinates of a point at which the sixth straight line meets the fifth straight line.

The non-stroke processor may set a size of the ball closest to the first straight line as the average size when the ball in the image does not pass between the first straight line and the second straight line.

The non-stroke processor may estimate the average size of the balls between the first straight line and the second straight line based on at least one of a degree of size change of the ball approaching the first straight line and a distance between the first straight line and the ball closest to the first straight line.

The non-stroke processor may adjust the upper limit value, the lower limit value and a height of the strike zone based on a height of a batter.

The baseball game system may further include a height input unit for inputting the height of the batter.

The non-stroke processor may adjust the upper limit value, the lower limit value and the height of the strike zone based on the height input to the height input unit.

The baseball game system may further include a human body sensor positioned on batter's boxes defining the determination area, the human body sensor determining presence of a batter and detecting a height of the batter.

The stroke processor may include a stroke coordinate converter calculating three-dimensional coordinates of the ball based on: a ball size determined, from one of the plurality of images, according to coordinates of a reference plane of a maximum projection angle area defined by a maximum projection angle of the photographing unit; a size of the ball displayed in the image; XY coordinates of the ball displayed in the image; and the maximum projection angle of the photographing unit.

The coordinate converter may include a ratio calculator calculating a coordinate conversion ratio by dividing the size of the ball displayed in the image by the ball size determined according to the coordinates of the reference plane of the maximum projection angle area.

The coordinate converter may further include a coordinate calculator calculating a Z coordinate of the ball by dividing a value obtained by multiplying the coordinate conversion ratio and a length of one side of the reference plane of the maximum projection angle area by a tangent value corresponding to the maximum projection angle of the photographing unit.

The coordinate calculator may calculate the XY coordinates of the ball by multiplying the coordinate conversion ratio and the XY coordinates of the ball displayed in the image.

The stroke processor may further include a trajectory calculator calculating a final location of the ball by analyzing the plurality of images.

The trajectory calculator may calculate a distance by which the ball moves for a predetermined time based on the three-dimensional coordinates of the ball and a time difference between the plurality of images and calculates a velocity of the ball based on the time difference and the moving distance.

The trajectory calculator may determine a result value, such as a foul, an out, a hit, a two-base hit, a three-base hit and a home run, of a struck ball based on the three-dimensional coordinates of the ball and the velocity of the ball.

The baseball game system may further include a swing determination unit determining whether or not a batter on one of batter's boxes on opposite sides of the strike zone has swung a baseball bat based on the image from the photographing unit. The swing determination unit may detect a batter's box on which the batter is positioned based on a degree of change in the image and determines whether or not a swing of the baseball bat has been made based on the detected batter's box and a trajectory of an end portion of the baseball bat.

The swing determination unit may set a first vector connecting two temporally adjacent end portions and sets a second vector perpendicular to the first vector, determine whether the number of second vectors toward the detected batter's box among the second vectors is within a first reference range, and determine whether an average length of the second vectors is within a second reference range, so as to determine whether or not a swing of the baseball bat has been made.

The swing determination unit may determine that a swing of the baseball bat has been made when the number of second vectors toward the detected batter's box among the second vectors is within the first reference range and the average length of the second vectors is within the second reference range.

The swing determination unit may further determine whether a sum of lengths of the first vectors is within a third reference range.

The swing determination unit may determine that a swing of the baseball bat has been made when the number of second vectors toward the detected batter's box among the second vectors is within the first reference range, the average length of the second vectors is within the second reference range, and the sum of the lengths of the first vectors is within the third reference range.

The baseball bat may further include a marking pattern.

The marking pattern may be positioned at an end portion of the baseball bat.

The marking pattern may surround the end portion.

The marking pattern may have a lighter color than a color of the baseball bat.

The baseball game system may further include a determination unit determining a ball and a strike based on the determination result from the swing determination unit and the detection result from the non-stroke processor.

The foregoing is illustrative only and is not intend portioned to be in any way limiting. In addition to the illustrative aspects, exemplary embodiments and features described above, further aspects, exemplary embodiments and features will become apparent by reference to the drawings and the following detailed description.

### BRIEF DESCRIPTION OF THE DRAWINGS

A more complete appreciation of the present invention will become more apparent by describing in detail exemplary embodiments thereof with reference to the accompanying drawings, wherein:

FIG. 1 is a schematic perspective view illustrating a baseball game system according to an exemplary embodiment;

FIG. 2 is a side view of FIG. 1;

FIG. 3 is a view illustrating an image photographed by a photographing unit;

FIGS. 4A, 4B and 4C are explanatory views illustrating an operation of a non-stroke processor;

FIG. 5 is a flowchart illustrating an operation sequence of the non-stroke processor in FIGS. 4A, 4B and 4C;

FIG. 6 is a view illustrating a location of a ball in a standardized strike zone;

FIGS. 7A, 7B and 7C are another explanatory views illustrating the operation of the non-stroke processor;

FIGS. 8A, 8B and 8C are still another explanatory views illustrating the operation of the non-stroke processor;

FIG. 9 is a view illustrating a height input unit;

FIG. 10 is an explanatory view illustrating an operation of a human body sensor;

FIG. 11 is another side view of FIG. 1;

FIG. 12 is a perspective view illustrating that a ball is photographed according to a maximum projection angle of the photographing unit;

FIGS. 13, 14 and 15 are views illustrating an operation of a coordinate converter;

FIGS. 16, 17, 18 and 19 are views illustrating an operation of a trajectory calculator;

FIG. 20 is a flowchart illustrating an operation sequence of a stroke processor;

FIG. 21 is still another side view of FIG. 1;

FIG. 22 is a view illustrating an image photographed by a photographing unit;

FIGS. 23A and 23B are explanatory views illustrating an operation of a swing determination unit based on the image of FIG. 22;

FIG. 24 is a flowchart illustrating an operation sequence of the swing determination unit in FIGS. 23A and 23B;

FIG. 25 is a view illustrating a trajectory of a baseball bat in the case of a check swing;

FIG. 26 is a perspective view illustrating a baseball bat used in the baseball game system of FIG. 1;

FIG. 27 is a cross-sectional view taken along line I-P of FIG. 1;

FIG. 28 is a view illustrating an algorithm applied to the non-stroke processor;

FIG. 29 is a view illustrating an algorithm applied to the stroke processor; and

FIG. 30 is a view illustrating an algorithm applied to the swing determination unit.

### DETAILED DESCRIPTION

Exemplary embodiments will now be described more fully hereinafter with reference to the accompanying drawings. Although the invention may be modified in various manners and have several exemplary embodiments, exemplary embodiments are illustrated in the accompanying drawings and will be mainly described in the specification. However, the scope of the invention is not limited to the exemplary embodiments and should be construed as including all the changes, equivalents and substitutions included in the spirit and scope of the invention.

In the drawings, thicknesses of a plurality of layers and areas are illustrated in an enlarged manner for clarity and ease of description thereof. When a layer, area, or batter's box is referred to as being “on” another layer, area, or batter's box, it may be directly on the other layer, area, or batter's box, or intervening layers, areas, or batter's boxes may be present therebetween. Conversely, when a layer, area, or batter's box is referred to as being “directly on” another layer, area, or batter's box, intervening layers, areas, or batter's boxes may be absent therebetween. Further when a layer, area, or batter's box is referred to as being “below” another layer, area, or batter's box, it may be directly below the other layer, area, or batter's box, or intervening layers, areas, or batter's boxes may be present therebetween. Conversely, when a layer, area, or batter's box is referred to as being “directly below” another layer, area, or batter's box, intervening layers, areas, or batter's boxes may be absent therebetween.

The spatially relative terms “below”, “beneath”, “less”, “above”, “upper” and the like, may be used herein for ease of description to describe the relations between one element or component and another element or component as illustrated in the drawings. It will be understood that the spatially relative terms are intend portioned to encompass different orientations of the device in use or operation, in addition to the orientation depicted in the drawings. For example, in the case where a device illustrated in the drawing is turned over, the device locationed “below” or “beneath” another device may be placed “above” another device. Accordingly, the illustrative term “below” may include both the lower and upper locations. The device may also be oriented in the other direction and thus the spatially relative terms may be interpreted differently depend portioning on the orientations.

Throughout the specification, when an element is referred to as being “connected” to another element, the element is “directly connected” to the other element, or “electrically connected” to the other element with one or more intervening elements interposed therebetween. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that, although the terms “first,” “second,” “third,” and the like may be used herein to describe various elements, these elements should not be limited by these terms. These terms are only used to distinguish one element from another element. Thus, “a first element” discussed below could be termed “a second element” or “a third element,” and “a second element” and “a third element” may be termed likewise without departing from the teachings herein.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value.

Unless otherwise defined, all terms used herein (including technical and scientific terms) have the same meaning as commonly understood by those skilled in the art to which this invention pertains. It will be further understood that terms, such as those defined in commonly used dictionaries, should be interpreted as having a meaning that is consistent with their meaning in the context of the relevant art and will not be interpreted in an ideal or excessively formal sense unless clearly defined in the present specification.

Some of the parts which are not associated with the description may not be provided in order to specifically describe exemplary embodiments of the present invention and like reference numerals refer to like elements throughout the specification.

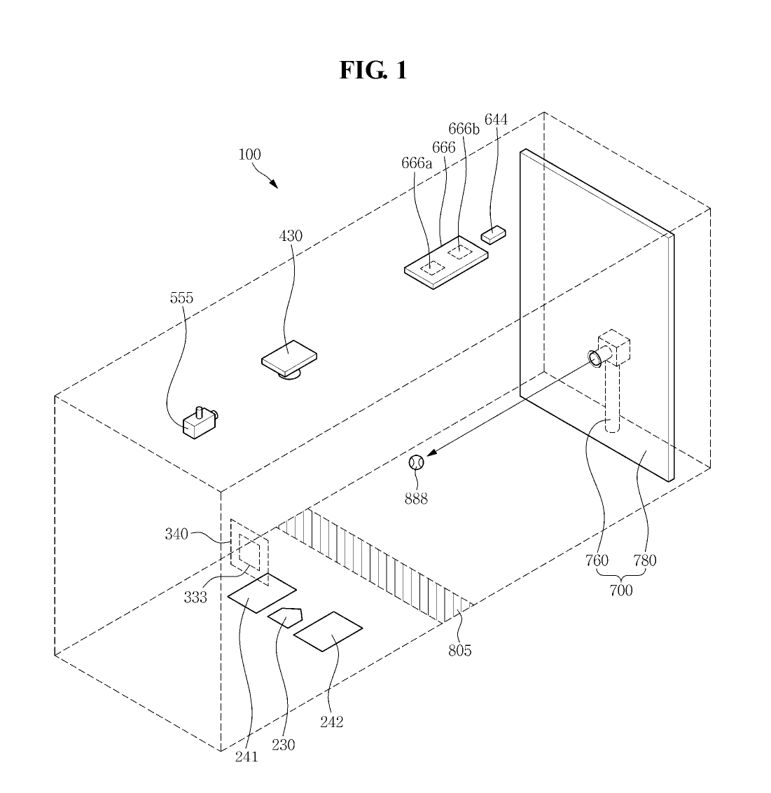

Hereinafter, a baseball game system according to an exemplary embodiment will be described in detail with reference to FIGS. 1 to 30.

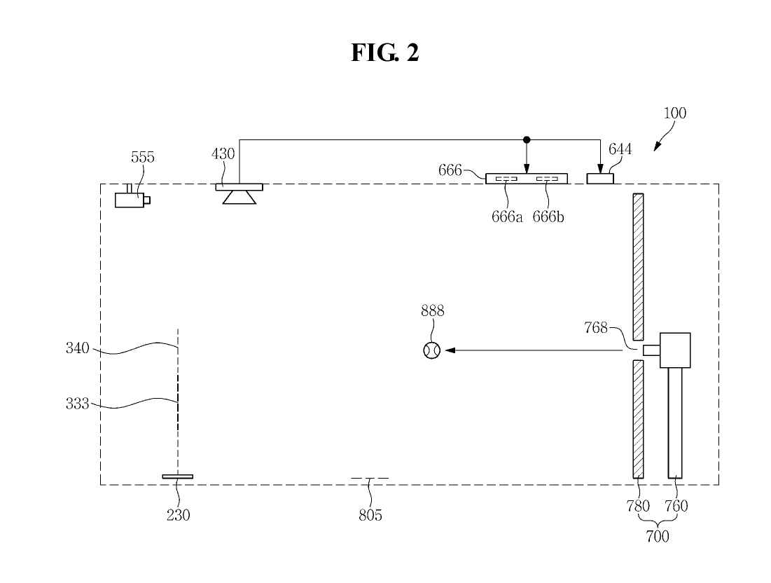

FIG. 1 is a schematic perspective view illustrating a baseball game system according to an exemplary embodiment, and FIG. 2 is a side view of FIG. 1.

As illustrated in FIGS. 1 and 2, the baseball game system 100 according to an exemplary embodiment includes a pitching unit 700, a photographing unit 430, a projector 555, a location detector 666, a first batter's box 241, a second batter's box 242, a groove plate 230 and a swing determination unit 644.

The pitching unit 700 pitches a ball 888 toward a determination area 340 between the first batter's box 241 and the second batter's box 242.

The determination area 340 includes a strike zone 333. That is, a part of the determination area 340 is the strike zone 333. For example, the determination area 340 may be positioned between the first batter's box 241 and the second batter's box 242.

A width of the determination area 340 may be defined by a distance between the first batter's box 241 and the second batter's box 242, and a length of the determination area 340 may be defined by a distance between the groove plate 230 and an imaginary side above the groove plate 230. Herein, the imaginary side is positioned higher than an upper side of the strike zone 333.

The pitching unit 700 includes a screen 780 and a pitching machine 760.

The screen 780 is positioned between the determination area 340 and the pitching machine 760. The screen 780 displays an image projected from the projector 555. The image is displayed on a display surface of the screen 780. As illustrated in FIG. 2, the screen 780 has at least one hole 768.

The pitching machine 760 is positioned behind the screen 780. That is, the pitching machine 760 is positioned opposite the display surface of the screen 780. The pitching machine 760 throws the ball 888. The ball 888 pitched from the pitching machine 760 passes through the hole 768 of the screen 780 and advances toward the determination area 340.

The photographing unit 430 detects a moment when the ball 888 from the pitching unit 700 enters a sensing area 805 and starts photographing. For example, the photographing unit 460 starts tracking all moving objects, including the ball 888, from the moment when the ball 888 enters the sensing area 805. To this end, the photographing unit 430 may continuously photograph at a rate of several tens to several hundreds of frames per second from the moment when the ball 888 enters the sensing area 805. The photographing unit 430 may include a high-speed camera.

The photographing unit 430 is positioned above the determination area 340. For example, as illustrated in FIG. 2, the photographing unit 430 may be positioned in a diagonal direction of the determination area 340, not directly above the determination area 340.

The location detector 666 detects a location of the ball 888 based on the image photographed by the photographing unit 430. The image provided from the photographing unit 430 includes a plurality of frame images. The location detector 666 may analyze the frame images to calculate coordinates (XY coordinates) of the ball 888 in the determination area 340. To this end, for example, the location detector 666 may binarize each frame image from the photographing unit 430 based on a corresponding photographing illuminance thereof to generate a black-white image, extract a basic contour (e.g., a contour of a ball) of a subject (e.g., a ball) in the image by scanning the black-white image in the up-and-down direction and the left-and-right direction, determine a center position of the subject from the contour, and determine a location of the subject (e.g., the ball) based on the center position and a trajectory of the subject (e.g., a trajectory of the ball).

The location detector 666 includes a non-stroke processor 666a and a stroke processor 666b.

The non-stroke processor 666a detects a location of the ball 888 that is not struck based on the photographed image from the photographing unit 430. The stroke processor detects a location of the ball 888 that is struck based on the photographed image from the photographing unit 430.

The coordinate information of the ball detected from the non-stroke processor 666a is transmitted to a determination unit (not illustrated). The determination unit determines whether or not the coordinates of the detected ball are located in the strike zone 333 in the determination area. As a result of the determination, in the case where it is determined that the ball 888 is located inside the strike zone 333 or at the boundary thereof, the determination unit declares a strike. On the other hand, in the case where it is determined that the ball is located in the determination area 340 outside the strike zone 300, the determination unit declares a ball. In an exemplary embodiment, the determination unit determines final ball and strike based on a determination result from a swing determination unit 644 to be described below and the detection result from the non-stroke processor 666a.

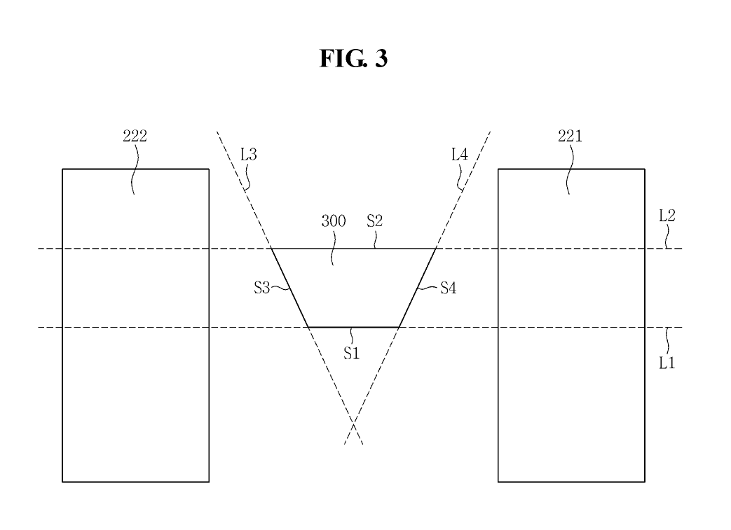

FIG. 3 is a view illustrating an image photographed by a photographing unit.

FIG. 3 is a view illustrating an image photographed by the photographing unit 430. A strike zone 300 illustrated in FIG. 3 is an image of the strike zone 333 in FIG. 1 described above, a first batter's box 221 illustrated in FIG. 3 is an image of the first batter's box 241 in FIG. 1 described above, and a second batter's box 222 illustrated in FIG. 3 is an image of the second batter's box 242 in FIG. 1 described above.

The non-stroke processor 666a sets the strike zone 300 based on the image photographed by the photographing unit 430. For example, the strike zone 300 may be defined as an area surrounded by four imaginary straight lines L1, L2, L3 and L4.

A first straight line L1 and a second straight line L2 face each other and a third straight line L3 and a fourth straight line L4 face each other. The first straight line L1 and the second straight line L2 may be arranged parallel to each other.

The first straight line L1 defines a lower side S1 of the strike zone 300, the second straight line L2 defines an upper side S2 of the strike zone 300, the third straight line L3 defines a left side S3 of the strike zone 300, and the fourth straight line L4 defines a right side S4 of the strike zone 300.

The photographing unit 430 photographs the strike zone 300 from a diagonal direction thereof rather than immediately above the strike zone 300. The strike zone 300 is shaped like a trapezoid to reflect the perspective phenomenon depending on the shooting angle. For example, the strike zone 300 may have a trapezoidal shape as illustrated in FIG. 3. Since the upper side S2 of the strike zone 300 is positioned relatively closer to the photographing unit 430 than the lower side S1 of the strike zone 300 is thereto, the upper side S2 has a longer length than the lower side S1.

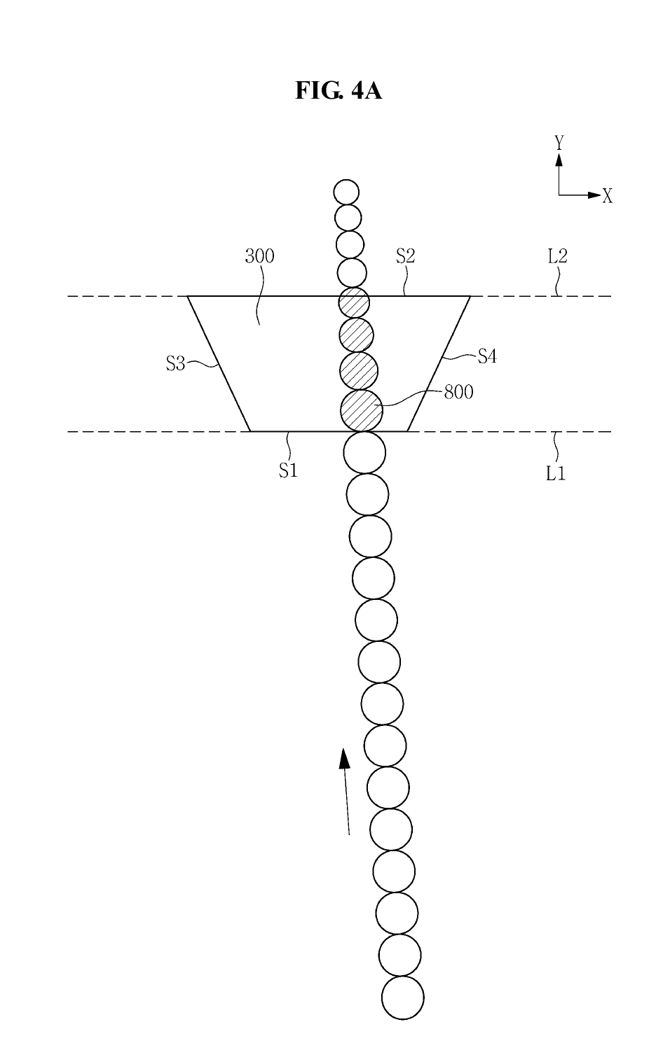

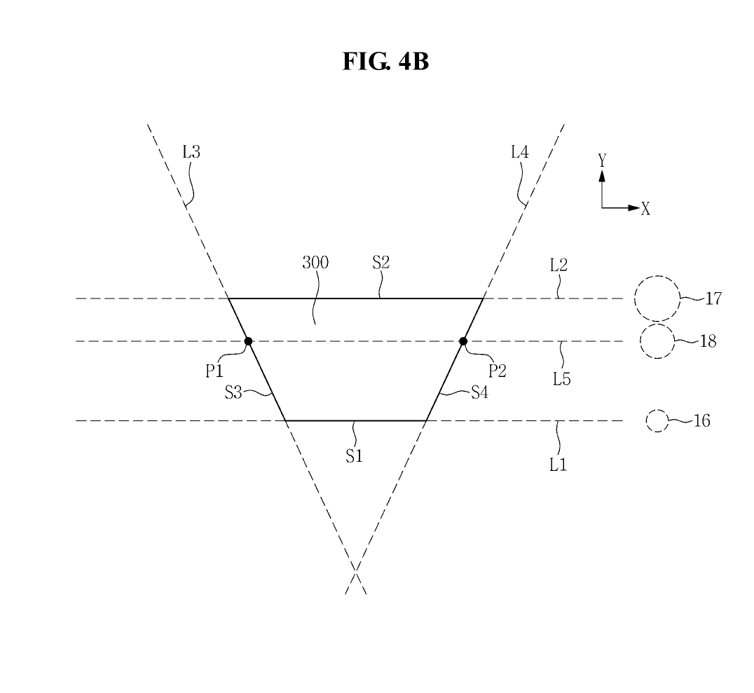

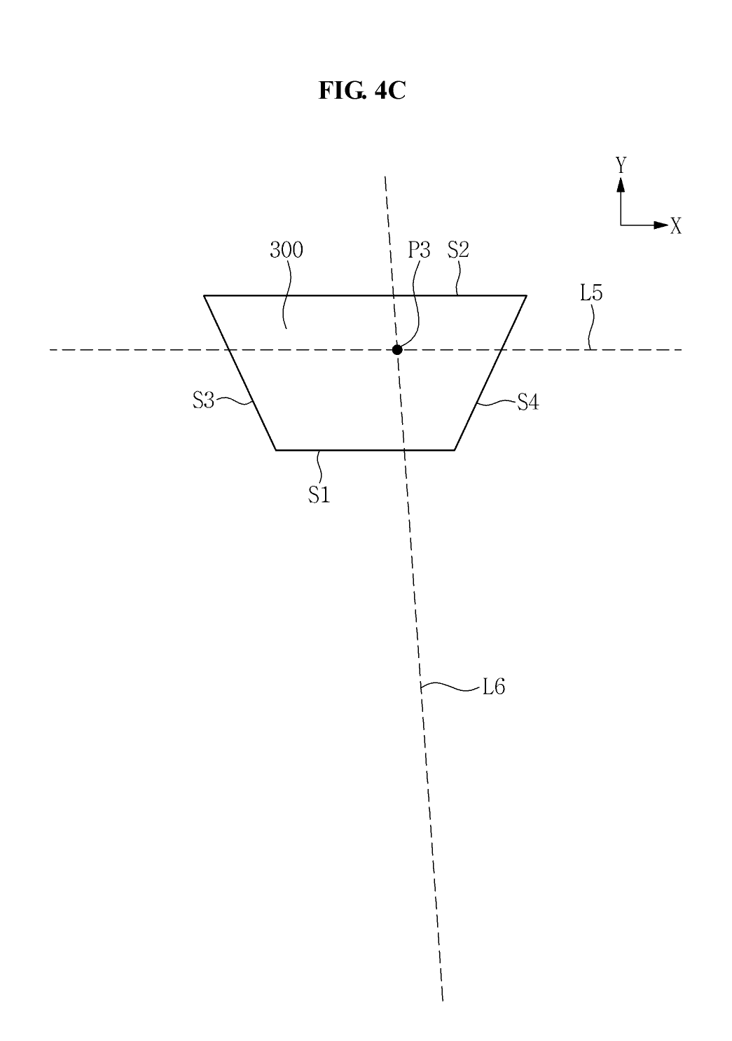

The ball in the image has a larger size as it approaches the photographing unit 430 due to the perspective phenomenon. That is, a size of a ball 800 (see FIG. 4A) in the image tells how high the ball 800 is from the ground (or the groove plate 230). In other words, a vertical location of the ball 800 may be determined from the size of the ball 800 in the image.

The non-stroke processor 666a may determine the size of the ball 800 using a predetermined reference value. The reference value may include a lower limit value and an upper limit value.

The first straight line L1 defining the lower side S1 of the strike zone 300 represents a location of the ball 800 at a lowest position in the strike zone 300 and the second straight line L2 defining the upper side S2 of the strike zone 300 represents a location of the ball 800 at a highest position in the strike zone 300

A size (hereinafter, a lower limit value) of the ball 800 when the ball 800 is positioned on the first straight line L1 and a size (hereinafter, an upper limit value) of the ball 800 when the ball 800 is positioned on the second straight line L2 may be set to predetermined values. The lower limit value is less than the upper limit value. The lower limit value and the upper limit value may be input from the outside.

Hereinafter, an operation of the non-stroke processor 666a will be described in detail.

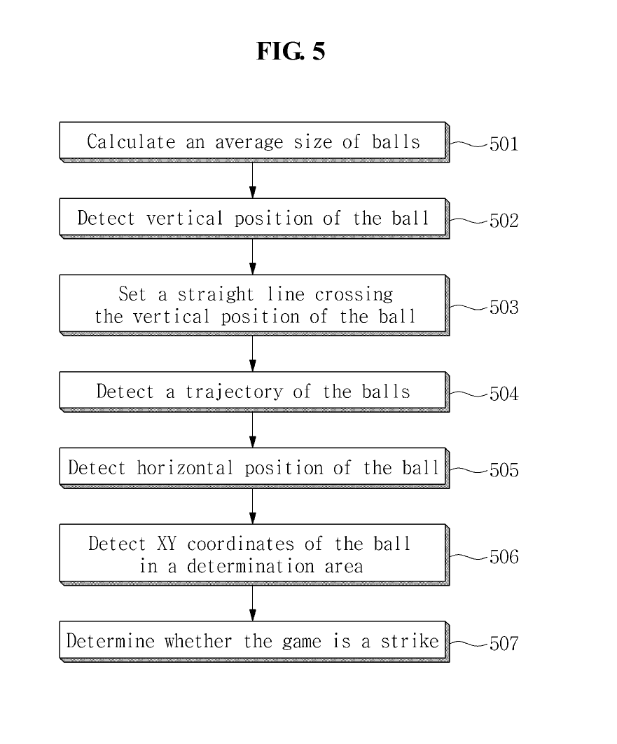

FIGS. 4A, 4B and 4C are explanatory views illustrating the operation of the non-stroke processor 666a, and FIG. 5 is a flowchart illustrating an operation sequence of the non-stroke processor 666a in FIGS. 4A, 4B and 4C. In an exemplary embodiment, the ball 800 in FIG. 4A is an image of the ball 888 in FIG. 1 described above. In FIGS. 4A, 4B and 4C, for ease of explanation, the first batter's box 221 and the second batter's box 222 are omitted.

First, suppose that the balls 800 in a plurality of continuously photographed images pass through the determination area 340 with a trajectory as illustrated in FIG. 4A.

The non-stroke processor 666a selects balls 800 located between the first straight line L1 and the second straight line L2 in the plurality of continuously photographed images and calculates an average size of the balls 800 (501). As an example, as illustrated in FIG. 4A, there are four balls 800 (hatched balls) positioned between the first straight line L1 and the second straight line L2 and the four balls 800 each have different sizes. That is, the ball 800 has a less size as it approaches the second straight line L2. The non-stroke processor 666a individually obtains respective diameters of the four balls 800 and then calculates an average size of the diameters. In an exemplary embodiment, the ball between the first straight line L1 and the second straight line L2 may include a ball crossing the first straight line L1 or the second straight line L2.

Subsequently, as illustrated in FIG. 4B, the non-stroke processor 666a detects a vertical location of the ball 800 in the determination area 340 based on the average size (502). In other words, the non-stroke processor 666a detects a Y coordinate of the ball in the determination area 340 having a two-dimensional planar shape.

To this end, the non-stroke processor 666a may detect the vertical location of the ball 800 by, for example, comparing the average size with a predetermined reference value. The reference value includes the lower limit value and the upper limit value described above.

A reference number 16 in FIG. 4 means a size of a ball corresponding to the lower limit value, a reference number 17 in FIG. 4 means a size of a ball corresponding to the upper limit value, and a reference number 18 in FIG. 4 means a size of a ball corresponding to the average size of the balls described above, which may or may not be illustrated in the image.

As such, the non-stroke processor 666a may compare the average size, the upper limit value and the lower limit value to calculate coordinates of a point indicating the vertical location of the ball 800 on the third straight line L3 based on the comparison result, which will be described in detail below.

For example, the non-stroke processor 666a divides the third straight line L3 into a plurality of sections based on the location of the lower limit value and the location of the upper limit value. In such an exemplary embodiment, the third straight line L3 may be divided into the plurality of sections so that one of points at a boundary between the sections corresponds to the location of the aforementioned lower limit value and another of the points at the boundary corresponds to the location of the upper limit value.

Each point is assigned with a different location value. Each location value is determined according to a ratio between the lower limit value and the upper limit value. The location value has a tendency to increase along a Y axis.

The non-stroke processor 666a finds a location value having a size coinciding with or closest to the average size and selects a point P1 (hereinafter, “a first point”) given the location value. A Y coordinate of the selected first point P1 means the vertical location of the ball 800 on the third straight line L3.

In such a manner, the non-stroke processor 666a may calculate coordinates of a point representing a vertical location of the ball on the fourth straight line L4, which will be described in detail below.

For example, the non-stroke processor 666a divides the fourth straight line L4 into a plurality of sections based on the location of the lower limit value and the location of the upper limit value. In such an exemplary embodiment, the fourth straight line L4 may be divided into the plurality of sections so that one of points at a boundary between the sections corresponds to the location of the aforementioned lower limit value and another of the points at the boundary corresponds to the location of the upper limit value.

Each point is assigned with a different location value. Each location value is determined according to a ratio between the lower limit value and the upper limit value. The location value has a tendency to increase along a Y axis.

The non-stroke processor 666a finds a location value having a size coinciding with or closest to the average size and selects a point P2 (hereinafter, “a second point”) given the location value. A Y coordinate of the selected second point P2 means the vertical location of the ball 800 on the fourth straight line L4.

The Y coordinate value of the first point P1 and the Y coordinate value of the second point P2 indicating the height of the ball 800 may be substantially the same.

In the case as in an example illustrated in FIG. 4B in which the average size is greater than the lower limit value and less than the upper limit value, the first point P1 is located on the left side S3 of the strike zone 300 and the second point P2 is located on the right side S4 of the strike zone 300.

Next, the non-stroke processor 666a sets a fifth straight line L5 passing through the first point P1 and the second point P2 (503).

Next, the non-stroke processor 666a sets a sixth straight line L6 based on a trajectory of the ball 800 as illustrated in FIG. 4C (504).

Subsequently, the non-stroke processor 666a calculates a horizontal location of the ball 800 in the determination area 340 based on coordinates of a point P3 (hereinafter, “a third point”) at which the sixth straight line L6 meets the fifth straight line L5. The coordinates of the third point P3 may be calculated based on an equation of the sixth straight line L6 and an equation of the fifth straight line L5. The XY coordinates of the third point P3 is a location of the ball 800 in the determination area 340 (506).

When the third point P3 is located in the strike zone 300, as illustrated in FIG. 4C, the determination unit determines this as a strike regardless of whether a swing of a baseball bat has been made (507).

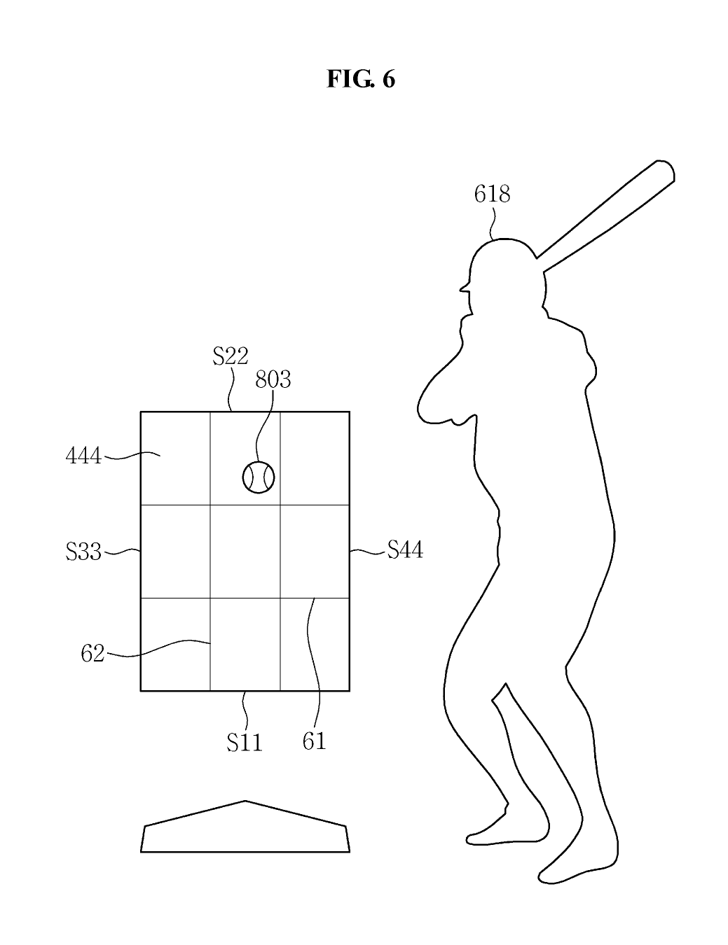

In an exemplary embodiment, based on the determination result from the determination unit, the projector 555 may display the location of the ball in the standardized strike zone on the screen, which will be described in detail with reference to FIG. 6.

FIG. 6 is a view illustrating the location of the ball in the standardized strike zone.

The projector 555 may project an image as illustrated in FIG. 6 on the screen 780. The image of FIG. 6 includes images of a strike zone 444, a batter 618 and a ball 803. The location of the ball 803 in FIG. 6 corresponds to the XY coordinates of the aforementioned third point P3.

The strike zone 444 illustrated in FIG. 6 has a quadrangular shape. A lower side S11, an upper side S22, a left side S33 and a right side S44 of the strike zone in FIG. 6 correspond to the lower side S1, the upper side S2, the left side S3 and the right side S4 of the strike zone 300 illustrated in FIG. 3, respectively.

In an exemplary embodiment, the strike zone 444 may include a horizontal grid line 61 and a vertical grid line 62 intersecting each other. The horizontal grid line 61 and the vertical grid line 62 divide the strike zone 444 into a plurality of areas. An approximate location of the ball in the strike zone 444 may be easily determined by the horizontal grid line 61 and the vertical grid line 62.

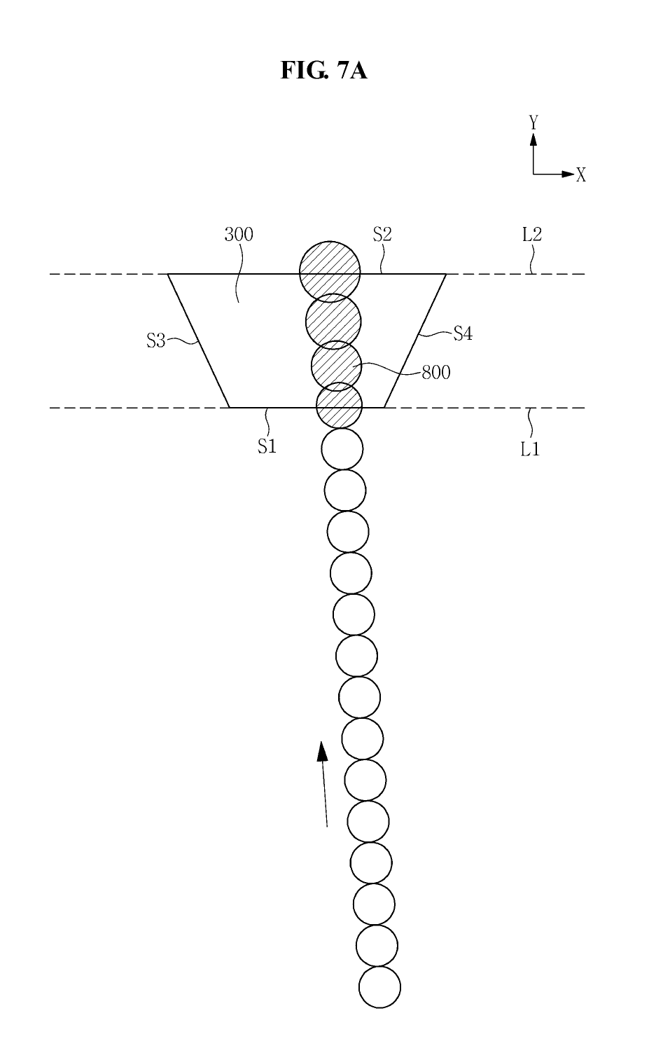

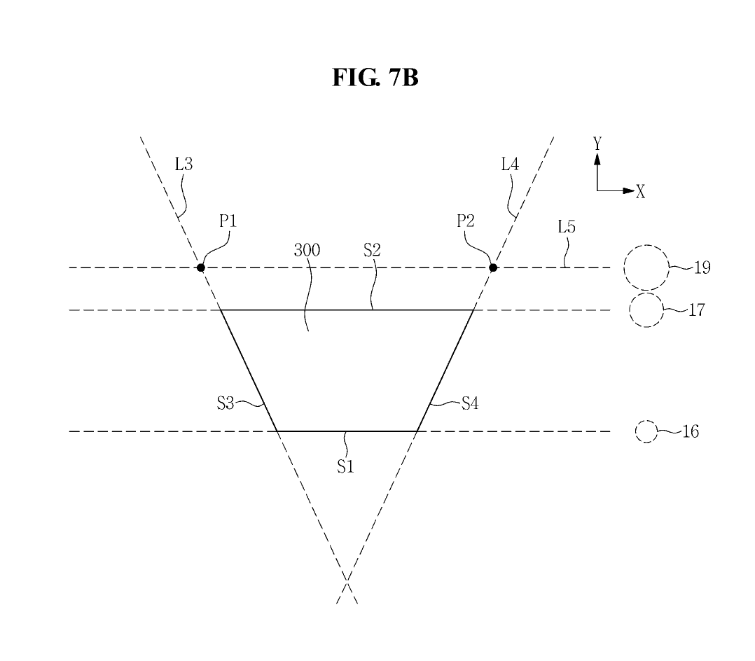

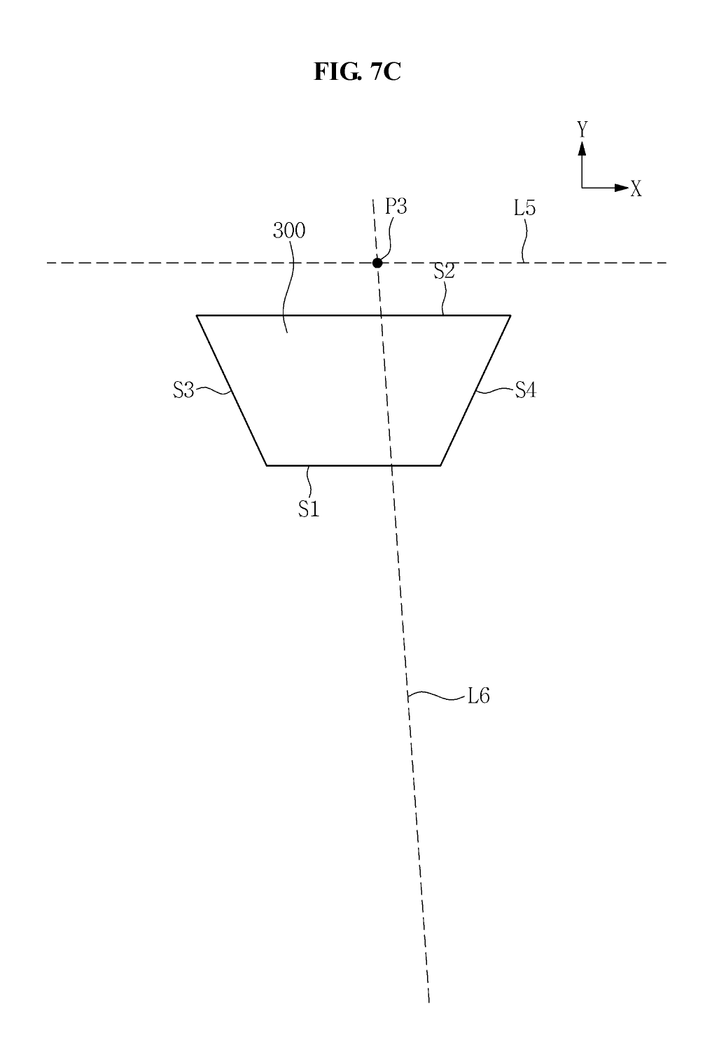

FIGS. 7A, 7B and 7C are another explanatory views illustrating the operation of the non-stroke processor 666a. In an exemplary embodiment, the ball 800 in FIG. 7A is an image of the ball 888 illustrated in FIG. 1 described above. In FIGS. 7A, 7B, and 7C, for ease of explanation, the first batter's box 221 and the second batter's box 222 are omitted.

First, suppose that the balls 800 in a plurality of continuously photographed images pass through the determination area 340 with a trajectory as illustrated in FIG. 7A.

The non-stroke processor 666a selects balls 800 located between the first straight line L1 and the second straight line L2 in the plurality of continuously photographed images and calculates an average size of the balls 800. As an example, as illustrated in FIG. 7A, there are four balls 800 (hatched balls) positioned between the first straight line L1 and the second straight line L2, and the four balls 800 each have different sizes. That is, the ball 800 has a larger size as it approaches the second straight line L2. The non-stroke processor 666a individually obtains respective diameters of the four balls 800 and then calculates an average size of the diameters. In an exemplary embodiment, the ball between the first straight line L1 and the second straight line L2 may include a ball crossing the first straight line L1 or the second straight line L2.

Subsequently, as illustrated in FIG. 7B, the non-stroke processor 666a detects a vertical location of the ball 800 in the determination area 340 based on the average size. In other words, the non-stroke processor 666a detects a Y coordinate of the ball in the determination area 340 having a two-dimensional planar shape.

To this end, the non-stroke processor 666a may detect the vertical location of the ball 800 by, for example, comparing the average size with a predetermined reference value. The reference value includes the lower limit value and the upper limit value described above.

A reference number 16 in FIG. 7B means a size of a ball corresponding to the lower limit value, a reference number 17 in FIG. 7B means a size of a ball corresponding to the upper limit value, and a reference number 19 in FIG. 7B means a size of a ball corresponding to the average size of the balls described above, which may or may not be illustrated in the image.

As such, the non-stroke processor 666a may compare the average size, the upper limit value and the lower limit value to calculate coordinates of a point indicating a vertical location of the ball 800 on the third straight line L3 based on the comparison result, which will be described in detail below.

For example, the non-stroke processor 666a divides the third straight line L3 into a plurality of sections based on the location of the lower limit value and the location of the upper limit value. In such an exemplary embodiment, the third straight line L3 may be divided into the plurality of sections so that one of points at a boundary between the sections corresponds to the location of the aforementioned lower limit value and another of the points at the boundary corresponds to the location of the upper limit value.

Each point is assigned with a different location value. Each location value is determined according to a ratio between the lower limit value and the upper limit value. The location value has a tendency to increase along a Y axis.

The non-stroke processor 666a finds a location value having a size coinciding with or closest to the average size and selects a point P1 (hereinafter, “a first point”) given the location value. A Y coordinate of the selected first point P1 means the vertical location of the ball 800 on the third straight line L3.

In such a manner, coordinates of a point indicating a vertical location of the ball on the fourth straight line L4 may be calculated, which will be described in detail below.

For example, the non-stroke processor 666a divides the fourth straight line L4 into a plurality of sections based on the location of the lower limit value and the location of the upper limit value. In such an exemplary embodiment, the fourth straight line L4 may be divided into the plurality of sections so that one of points at a boundary between the sections corresponds to the location of the aforementioned lower limit value and another of the points at the boundary corresponds to the location of the upper limit value.

Each point is assigned with a different location value. Each location value is determined according to a ratio between the lower limit value and the upper limit value. The location value has a tendency to increase along a Y axis.

The non-stroke processor 666a finds a location value having a size coinciding with or closest to the average size and selects a point P2 (hereinafter, “a second point”) given the location value. A Y coordinate of the selected second point P2 means the vertical location of the ball 800 on the fourth straight line L4.

The Y coordinate value of the first point P1 and the Y coordinate value of the second point P2 indicating the height of the ball 800 may be substantially the same.

In the case as in an example illustrated in FIG. 7B in which the average size is greater than the upper limit value, the first point P1 is located on the third straight line L3 higher than the upper side S2 of the strike zone 300 and the second point P2 is located on the fourth straight line IA higher than the upper side S2 of the strike zone 300.

Next, the non-stroke processor 666a sets a fifth straight line L5 passing through the first point P1 and the second point P2.

Next, the non-stroke processor 666a sets a sixth straight line L6 based on a trajectory of the ball 800 as illustrated in FIG. 7C.

Subsequently, the non-stroke processor 666a calculates a horizontal location of the ball 800 in the determination area 340 based on coordinates of a point P3 (hereinafter, “a third point”) at which the sixth straight line L6 meets the fifth straight line L5 (505). The coordinates of the third point P3 may be calculated based on an equation of the sixth straight line L6 and an equation of the fifth straight line L5. The XY coordinates of the third point P3 is a location of the ball 800 in the determination area 340.

As illustrated in FIG. 7C, in the case where the third point P3 is located outside the strike zone 300 and the swing of the baseball bat is not made, the determination unit determines this as a ball. On the other hand, as illustrated in FIG. 7C, in the case where the third point P3 is located outside the strike zone 300 and the swing of the baseball bat has been made, the determination unit determines this as a strike.

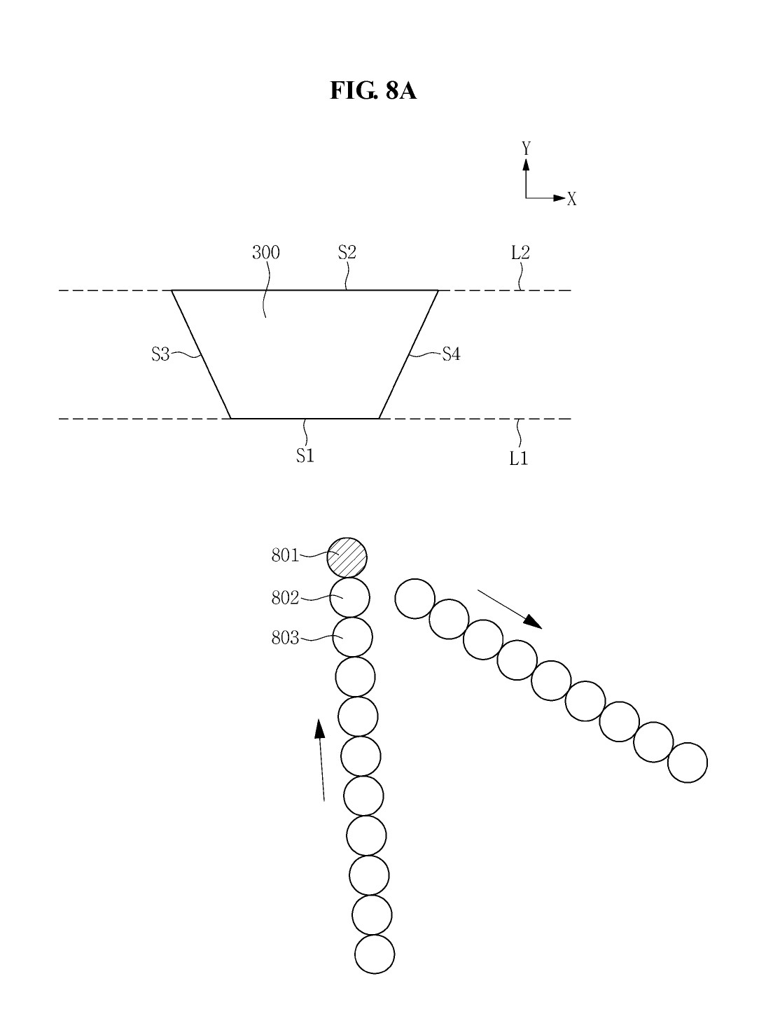

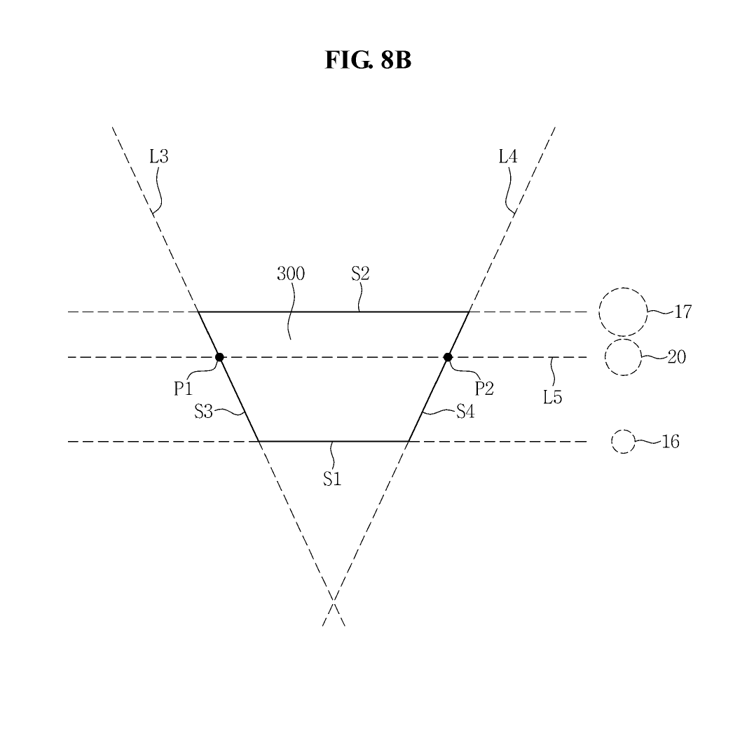

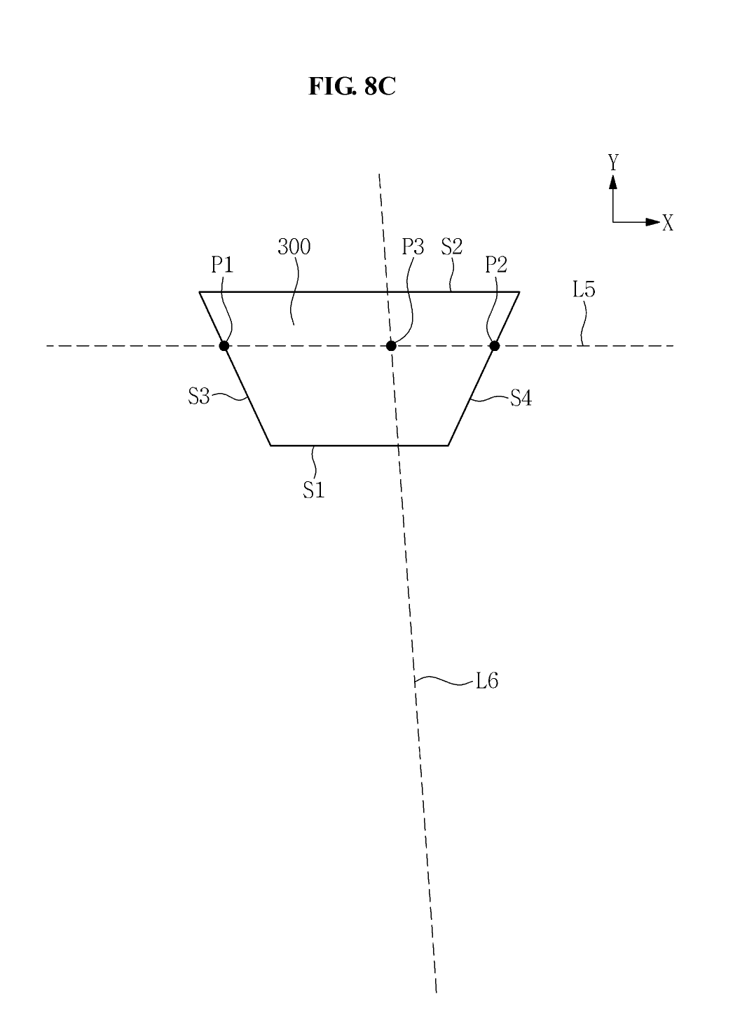

FIGS. 8A, 8B and 8C are still another explanatory views illustrating the operation of the non-stroke processor 666a. Meanwhile, a ball 800 in FIG. 8A is an image of the ball 888 in FIG. 1 described above. In FIGS. 8A, 8B and 8C, for convenience of explanation, the first batter's box 221 and the second batter's box 222 are omitted.

First, suppose that the balls in a plurality of continuously photographed images proceed toward the determination area 340 with a trajectory as illustrated in FIG. 8A, and the proceeding direction changes by a stroke. In such an exemplary embodiment, the ball may not pass through the determination area 340. In other words, there is no ball between the first straight line L1 and the second straight line L2.

The non-stroke processor 666a may even predict or estimate a location of the struck ball in the determination area 340 through a ball trajectory before the striking. To this end, the non-stroke processor 666a sets a size of a ball closest to the first straight line L1 as the aforementioned average size. For example, the non-stroke processor 666a may set a diameter of a ball 801 emphasized by a hatched portion in FIG. 8A as the average size. Alternatively, the non-stroke processor 666a may set a diameter of the ball 801 closest to the first straight line L1 and several balls 802 and 803 close to the ball 801 as the average size. For example, the non-stroke processor 666a may set an average size of the three balls 801, 802 and 803 illustrated in FIG. 8A as the aforementioned average size.

For a more accurate size calculation, the non-stroke processor 666a may estimate the average size based on a degree of size change of the balls 801, 802 and 803 gradually approaching the first straight line L1 a distance between the first straight line L1 and the ball closest to the first straight line L1. In other words, the non-stroke processor 666a may correct the average size based on the degree of size change of the balls 801, 802 and 803 gradually approaching the first straight line L1 and the distance between the first straight line L1 and the ball closest to the first straight line L1.

For example, in the case where the degree of size change of the balls 801, 802 and 803 gradually increases, the non-stroke processor 666a may increase a correction value for correcting the average size. On the other hand, in the case where the degree of size change of the balls 801, 802 and 803 gradually decreases, the non-stroke processor 666a may reduce the correction value for correcting the average size.

In addition, for example, in the case where the distance between the first straight line L1 and the ball 801 closest to the first straight line L1 is small, the non-stroke processor 666a may reduce the correction value for correcting the average size. On the other hand, in the case where the distance between the first straight line L1 and the ball 801 closest to the first straight line L1 is large, the non-stroke processor 666a may increase the correction value for correcting the average size.

Such a correction operation may be omitted.

Next, as illustrated in FIG. 8B, the non-stroke processor 666a detects a vertical location of the ball 800 in the determination area 340 based on the average size. In other words, the non-stroke processor 666a detects a Y coordinate of the ball in the determination area 340 having a two-dimensional planar shape.

To this end, the non-stroke processor 666a may detect the vertical location of the ball 800 by, for example, comparing the average size with a predetermined reference value. The reference value includes the lower limit value and the upper limit value described above.

A reference number 16 in FIG. 8B means a size of a ball corresponding to the lower limit value, a reference number 17 in FIG. 8B means a size of a ball corresponding to the upper limit value, and a reference number 20 in FIG. 8B means a size of a ball corresponding to the average size of the balls described above, which′ may or may not be illustrated in the image.

As such, the non-stroke processor 666a may compare the average size, the upper limit value and the lower limit value to calculate coordinates of a point indicating the vertical location of the ball 800 on a third straight line L3 based on the comparison result, which will be described in detail below.

For example, the non-stroke processor 666a divides the third straight line L3 into a plurality of sections based on the location of the lower limit value and the location of the upper limit value. In such an exemplary embodiment, the third straight line L3 may be divided into the plurality of sections so that one of points at a boundary between the sections corresponds to the location of the aforementioned lower limit value and another of the points at the boundary corresponds to the location of the upper limit value.

Each point is assigned with a different location value. Each location value is determined according to a ratio between the lower limit value and the upper limit value. The location value has a tendency to increase along a Y axis.

The non-stroke processor 666a finds a location value having a size coinciding with or closest to the average size and selects a point P1 (hereinafter, “a first point”) given the location value. A Y coordinate of the selected first point P1 means the vertical location of the ball 800 on the third straight line L3.

In such a manner, the non-stroke processor 666a may calculate coordinates of a point indicating a vertical location of the ball on a fourth straight line L4, which will be described in detail below.

For example, the non-stroke processor 666a divides the fourth straight line L4 into a plurality of sections based on the location of the lower limit value and the location of the upper limit value. In such an exemplary embodiment, the fourth straight line L4 may be divided into the plurality of sections so that one of points at a boundary between the sections corresponds to the location of the aforementioned lower limit value and another of the points at the boundary corresponds to the location of the upper limit value.

Each point is assigned with a different location value. Each location value is determined according to a ratio between the lower limit value and the upper limit value. The location value has a tendency to increase along a Y axis.

The non-stroke processor 666a finds a location value having a size coinciding with or closest to the average size and selects a point P2 (hereinafter, “a second point”) given the location value. A Y coordinate of the selected second point P2 means the vertical location of the ball 800 on the fourth straight line L4.

The Y coordinate value of the first point P1 and the Y coordinate value of the second point P2 indicating the height of the ball 800 may be substantially the same.

In the case as in an example illustrated in FIG. 8B in which the average size is greater than the lower limit value and less than the upper limit value, the first point P1 is located on the left side S3 of a strike zone 300 and the second point P2 is located on the right side S4 of the strike zone 300.

Next, the non-stroke processor 666a sets a fifth straight line L5 passing through the first point P1 and the second point P2.

Next, the non-stroke processor 666a sets a sixth straight line L6 based on a trajectory of the balls 801, 802 and 803 as illustrated in FIG. 8C.

Subsequently, the non-stroke processor 666a calculates a horizontal location of the ball in the determination area 340 based on coordinates of a point P3 (hereinafter, “a third point”) at which the sixth straight line L6 meets the fifth straight line L5. The coordinates of the third point P3 may be calculated based on an equation of the sixth straight line L6 and an equation of the fifth straight line L5. The XY coordinates of the third point P3 is a location of the ball in the determination area 340 (506).

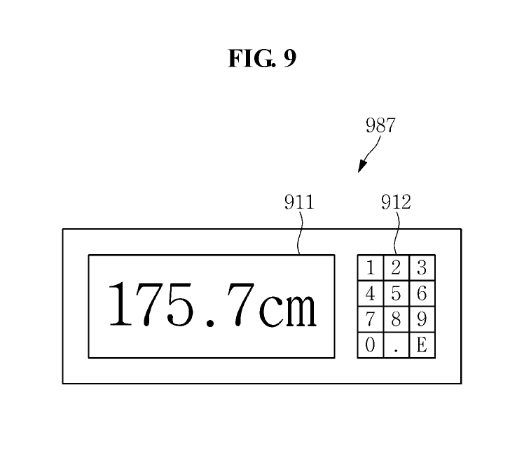

FIG. 9 is a view illustrating a height input unit.

As illustrated in FIG. 9, the baseball game system 100 according to an exemplary embodiment may further include a height input unit 987.

A height of a batter is input to the height input unit 987, and to this end, the height input unit 987 may include a display window 911 and an input means 912.

The input means 912 may be, for example, a keypad. A numerical value input by the input means 912 is displayed on the display window 911. FIG. 9 shows an example in which a height of 175.7 cm is input.

The non-stroke processor 666a adjusts the upper limit value and the lower limit value based on the height input to the height input unit 987, and sets a height of the strike zone 300 having the adjusted upper and lower limit values. For example, the non-stroke processor 666a may include a lookup table therein. In such an exemplary embodiment, the upper limit value, the lower limit value and the height of the strike zone 300 according to the height may be stored in advance in the lookup table. The non-stroke processor 666a finds an upper limit value, a lower limit value and a height of the strike zone 300 corresponding to the input height from the look-up table and sets the found values as the upper limit value, the lower limit value and the height of the strike zone 300.

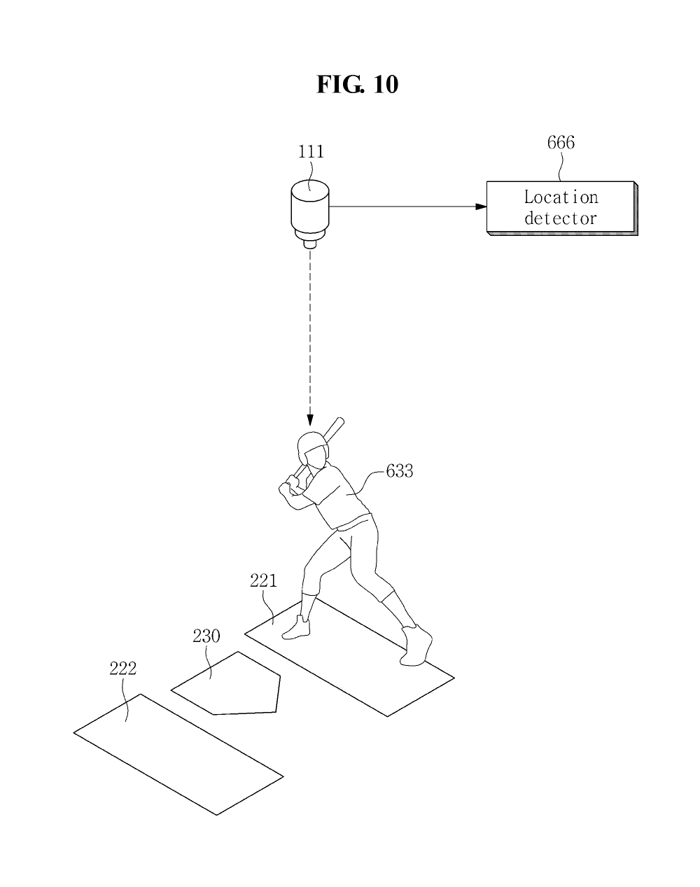

FIG. 10 is an explanatory view illustrating an operation of a human body sensor.

As illustrated in FIG. 10, the baseball game system 100 according to an exemplary embodiment may further include a human body sensor 111.

The human body sensor 111 may be positioned on at least one of the first batter's box 221 and the second batter's box 222. The human body sensor 111 irradiates a laser to the first batter's box 221 and the second batter's box 222 to determine the presence or absence of a user (hereinafter, a batter) 633.

The human body sensor 111 may further perform an operation of detecting a height of the batter 633 on the first batter's box 221 or the second batter's box 222. In such an exemplary embodiment, the human body sensor 111 may replace the aforementioned height input unit 987.

The non-stroke processor 666a adjusts the lower limit value, the upper limit value and the height of the strike zone 300 based on the height of the batter 633 detected by the human body sensor 111. In such an exemplary embodiment, the non-stroke processor 666a may include the aforementioned lookup table.

In an exemplary embodiment, the non-stroke processor 666a may further detect a time when the ball 800 is closest to the first straight line L1 and a time when the ball is closest to the second straight line L2. The non-stroke processor 666a may calculate a ball velocity based on the times.

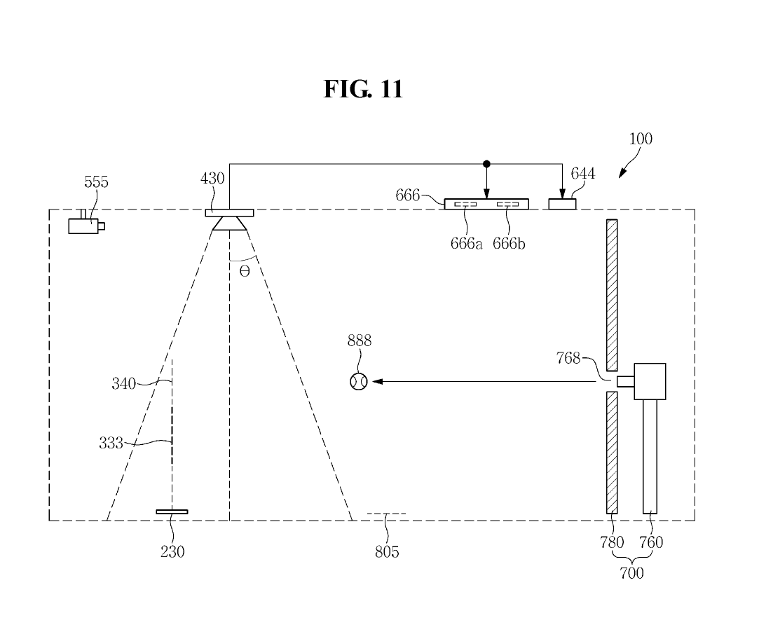

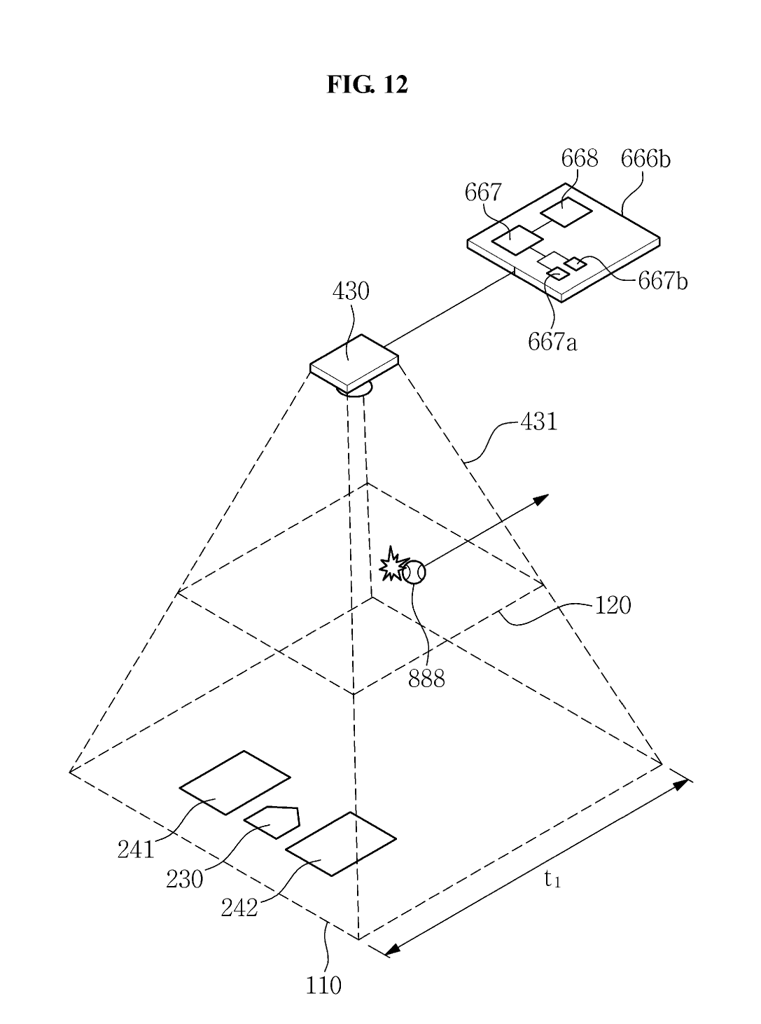

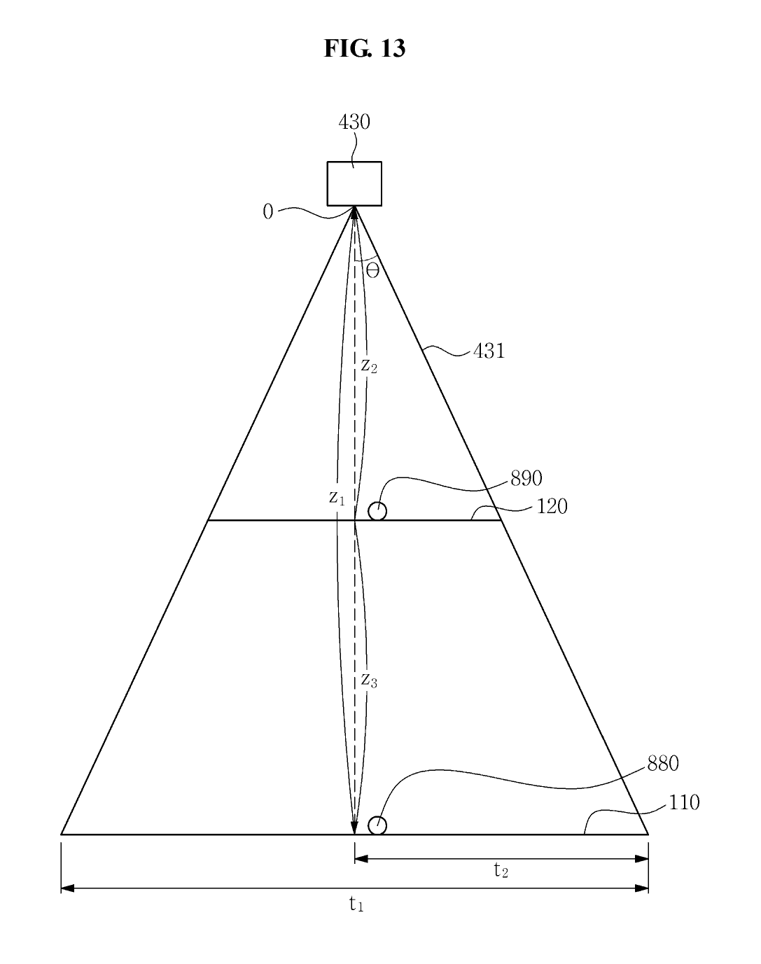

FIG. 11 is another side view of FIG. 1 to explain a maximum projection angle of the photographing unit 430. FIG. 12 is a perspective view illustrating that a ball is photographed according to the maximum projection angle of the photographing unit 430. FIGS. 13, 14 and 15 are views illustrating an operation of a coordinate converter.

Referring to FIGS. 11, 12 and 13, the photographing unit 430 photographs a maximum projection angle area 431 and transmits a plurality of images. In FIG. 12, the maximum projection angle of the photographing unit 430 is 2θ. That is, the photographing unit 430 may set the maximum projection angle unconstrainedly according to a place where the baseball game system is installed and the maximum projection angle area 431 that may be photographed by the photographing unit 430 is determined in accordance with the set maximum projection angle. The photographing unit 430 may photograph the ball 888 that entered the maximum projection angle area 431.

The stroke processor 666b detects a location of the ball 888 based on the plurality of images. The stroke processor 666b includes a coordinate converter 667 and a trajectory calculator 668.

The coordinate converter 667 calculates three-dimensional coordinates of the ball based on a ball size determined, from one of the plurality of images, according to coordinates of a reference plane 110 of the maximum projection angle area 431, a size of the ball displayed in the image, XY coordinates of the ball displayed in the image and the maximum projection angle of the photographing unit 430.

The trajectory calculator 667 analyzes the plurality of images and calculates a final location of the ball.

First, a process of the coordinate converter 667 calculating the three-dimensional coordinates of the ball will be described in detail.

The coordinate converter 667 includes a ratio calculator 667a and a coordinate calculator 667b.

The ratio calculator 667a calculates a coordinate conversion ratio by dividing the size of the ball displayed in the image by the size of the ball determined according to the coordinates of the reference plane 110 of the maximum projection angle area 431.

The coordinate calculator 667b divides a value obtained by multiplying the coordinate conversion ratio and a length of one side of the reference plane 110 of the maximum projection angle area 431 by a tangent value according to the maximum projection angle of the photographing unit 430, thus calculating a Z coordinate of the ball. In addition, the coordinate calculator 667b calculates the XY coordinates of the ball by multiplying the coordinate conversion ratio and the XY coordinates of the ball displayed in the image.

Referring to FIG. 13, first, a reference point 0 of the Z coordinate is defined as the photographing unit 430. In addition, the reference point 0 overlaps a center of the reference plane 110. Alternatively, an actual bottom surface on which the ball stroke occurs may be set as the reference point of the Z coordinate. The reference plane 110 of the maximum projection angle area 431 may be a bottom surface of a space to which the actual baseball system is applied. Alternatively, the reference plane 110 may be set as an imaginary plane of a different height. A plane that is set parallel to the reference plane 110 with respect to the Z coordinate of the actual three-dimensional coordinates of the ball 880 is defined as a photographing plane 120. Accordingly, the three-dimensional coordinates of the ball 880 positioned on the photographing plane 120 are three-dimensional coordinates of the ball desired to obtain.

When located on the reference plane 110, the Z coordinate of the ball is Z1, and when located on the photographing plane 120, the 7 coordinate of the ball is Z2. The maximum projection angle of the photographing unit 430 is 2θ. Since the reference plane 110 is an actual bottom surface, a length t1 of one side of the reference plane 110 may be measured. A length t2 corresponding to a half of one side of the reference plane 110 may also be obtained through the measured length t1 of the one side.

Accordingly, Z1 is defined as the following Equation 1 according to the law of trigonometric function.

Z1=length of one side of a reference plane/2/Tan θ=t2/Tan θ [Equation 1]

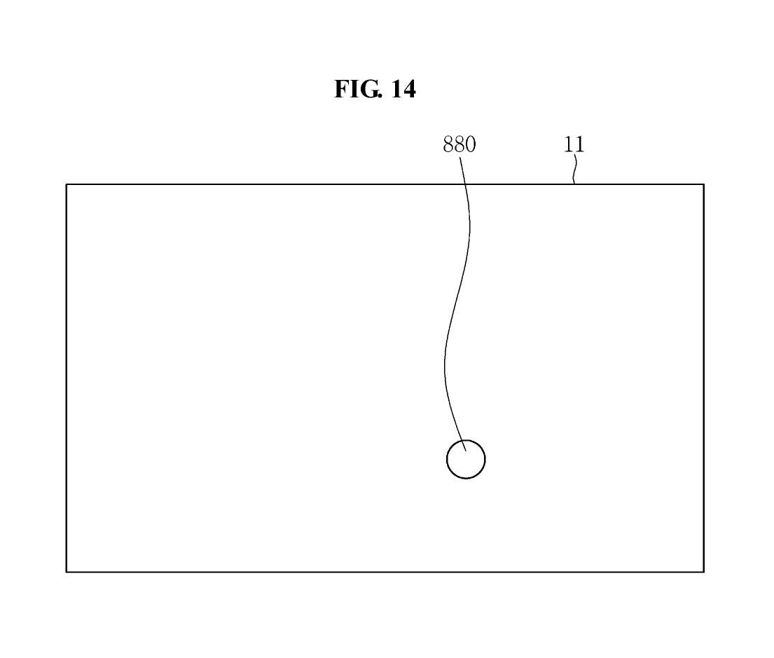

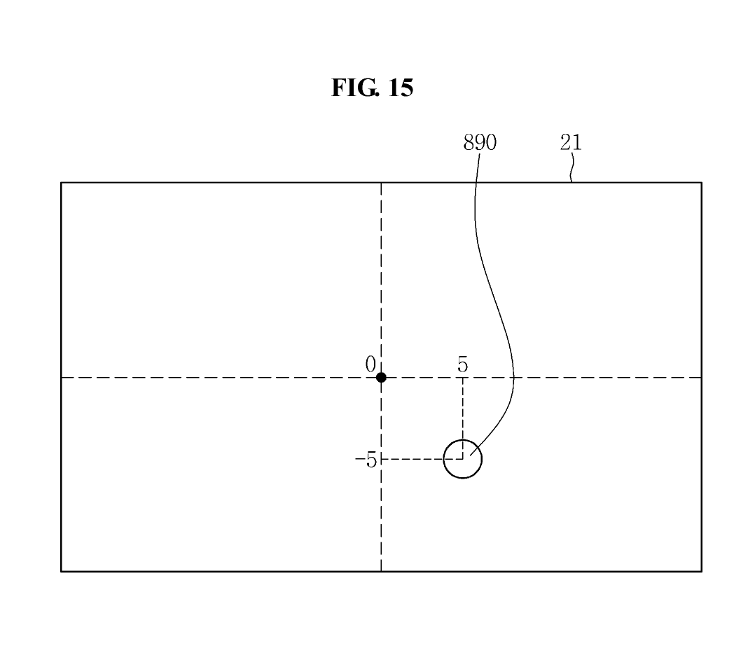

In an exemplary embodiment, a size of the balls 880 and 890 in the image photographed by the photographing unit 430 vary depending on the height of actual location. That is, as the balls 880 and 890 are further away from the photographing unit 430, the size of the balls 880 and 890 photographed in the image is reduced. For example, a first image 11 illustrated in FIG. 14 is an image illustrating a ball 880 on the reference plane 110 of FIG. 13. A second image 21 illustrated in FIG. 15 is an image illustrating a ball 890 on the photographing plane 120. Since the ball 880 on the reference plane 110 is farther away from the photographing unit 430 than the ball on the photographing plane 120 is therefrom, the ball 880 on the reference plane 110 in the first image 11 is less in size than the ball 890 of the second image 21.

Accordingly, actual heights of the balls 880 and 890, that is, the Z coordinate, may be determined based on the size of the balls 880 and 890 photographed in the image. For example, in the case where the size of the ball in the image is substantially equal to the size of the ball 880 in the first image 11 of FIG. 14, the Z coordinate of the ball in the image is substantially the same as the Z coordinate of the ball 880 in the first image 11. Accordingly, the size of the ball 880 photographed in the first image 11 becomes a reference value according to the coordinates of the reference plane 11 and the size of the ball 890 photographed by the photographing unit 430 is compared with the reference value to calculate the coordinate conversion ratio. The coordinate conversion ratio is as follows.

A coordinate conversion ratio=size of a ball displayed in an image/a reference value=size of the ball displayed in the image/size of the ball determined according to coordinates of a reference plane

For example, referring to FIGS. 14 and 15, the coordinate conversion ratio is the ball size of the second image/the ball size of the first image. In an exemplary embodiment, the size of the ball may be determined based on a diameter of the ball, for example.

Accordingly, when the coordinate conversion ratio is calculated using the size of the ball 880 determined according to the coordinates of the reference plane 11 and the size of the ball 890 displayed in the image and then the coordinate conversion ratio is multiplied by Equation 1, the actual Z coordinate of the ball may be obtained as in the following Equation 2.

Z2=Z1*a coordinate conversion ratio

=T2/tan θ*a coordinate conversion ratio

=T2/tan θ*size of the ball displayed in the image/size of the ball determined according to coordinates of a reference plane

=T2/Tan θ*a diameter of the ball in the image/a diameter of the ball determined according to the coordinates of the reference plane [Equation 2]

As such, the ratio calculator 667a calculates the coordinate conversion ratio based on the ball size determined according to the coordinates of the reference plane 110 of the maximum projection angle area 431 and the size of the ball displayed in the image. Then, the coordinate calculator 667b calculates the Z coordinate Z2 of the ball based on the coordinate conversion ratio, the maximum projection angle of the photographing unit 430, the Z coordinate Z1 of the ball when it is located on the reference plane 110 and the length t1 of one side of the reference plane 110. In an exemplary embodiment, when a bottom surface is set as a reference point O, the Z coordinate of the ball may use Z3.

In an exemplary embodiment, the XY coordinates of the ball 890 may be calculated based on the second image 21. First, a center of the second image 21 is set as the reference point O. According to the set reference point O, the XY coordinates of the ball 890 displayed in the second image 21 is determined with respect to a center of the ball 890. For example, as illustrated in FIG. 15, the XY coordinates of the ball 890 becomes (5, −5).

As such, when the aforementioned coordinate conversion ratio is applied to the XY coordinates of the ball 890 obtained based on the second image 21 as below, actual XY coordinates of the ball 890 may be obtained. The XY coordinates of the ball 890 displayed in the second image 21 are different from the actual XY coordinates of the ball and when the previously obtained coordinate conversion ratio is applied, the actual XY coordinates of the ball 890 displayed in the second image 21 may be obtained.

Actual X coordinate=X*a coordinate conversion ratio=X*size of the ball displayed in the image/size of the ball determined according to the coordinates of the reference plane

Actual Y coordinate=Y*a coordinate conversion ratio=Y*size of the ball displayed in the image/size of the ball determined according to the coordinates of the reference plane

As such, according to an exemplary embodiment, the three-dimensional coordinates of the ball 890 may be more accurately calculated based on the maximum projection angle of the photographing unit 430 and the coordinate conversion ratio. An algorithm for obtaining the three-dimensional coordinates according to an exemplary embodiment is as follows.

[Algorithm]

float tan = Mathf.Tan(arcOption.fieldOfview/2*Mathf.PI/180);
float w = imgWidth/2;
float h = imgHeight/2;
foreach(ARC_TARGET at in list)
{
float r = arcOption.balldiameter/at.size;
if(r>1) r=1; if(r<0) r=0;
float d = r/tan
float x = (at.pos.x−w)*r;
float y = (at.pos.y−h)*r;
float z = −d*w;
at.pos3D = new Vector3 (x,y,x);
}

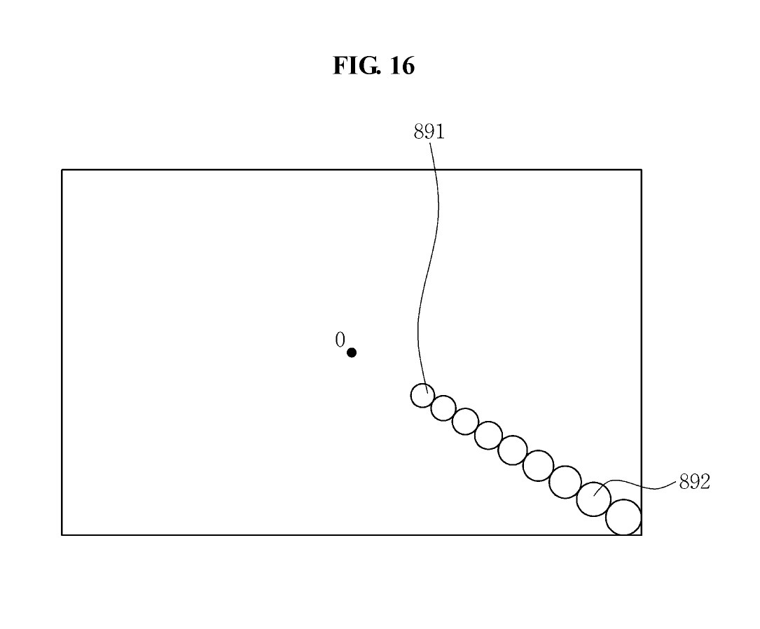

Hereinafter, an operation of the trajectory calculator will be described below with reference to FIGS. 16, 17, 18 and 19.

FIGS. 16, 17, 18 and 19 are views illustrating an operation of a trajectory calculator.

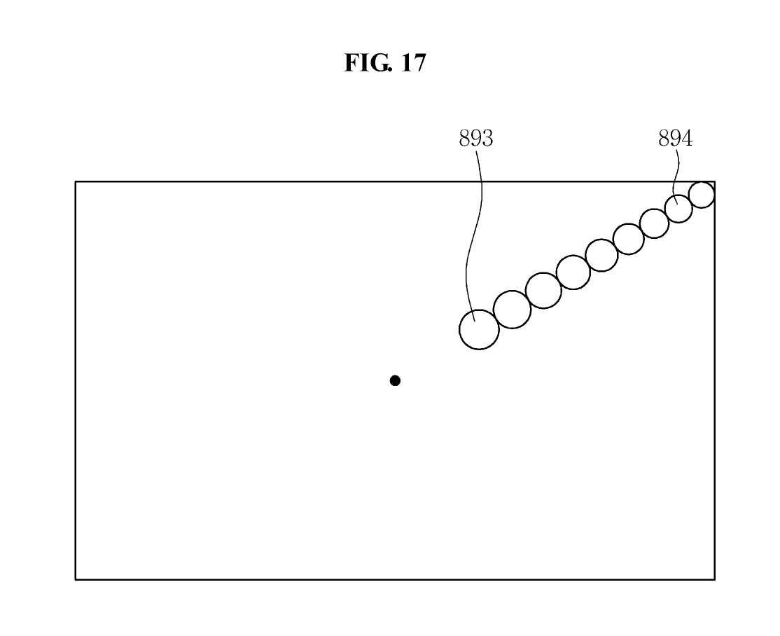

Referring to FIGS. 16, 17, 18 and 19, the trajectory calculator 668 (see FIG. 12) analyzes a plurality of images to calculate a final location of the ball. For example, FIG. 16 is a view illustrating overlap of a total of nine images taken at time intervals. A ball 891 relatively close to a center 0 is an image of a previously photographed ball 891 and a ball 892 relatively far from the center 0 is an image of a ball 892 photographed later in time. In the case where a diameter of the ball 892 photographed later is larger than a diameter of the previously photographed ball 891, the trajectory calculator 668 determines that the ball is gradually ascending. On the other hand, as illustrated in FIG. 17, in the case where a diameter of a ball 894 photographed later is less than a diameter of a previously photographed ball 893, the trajectory calculator 668 determines that the ball is gradually descending.

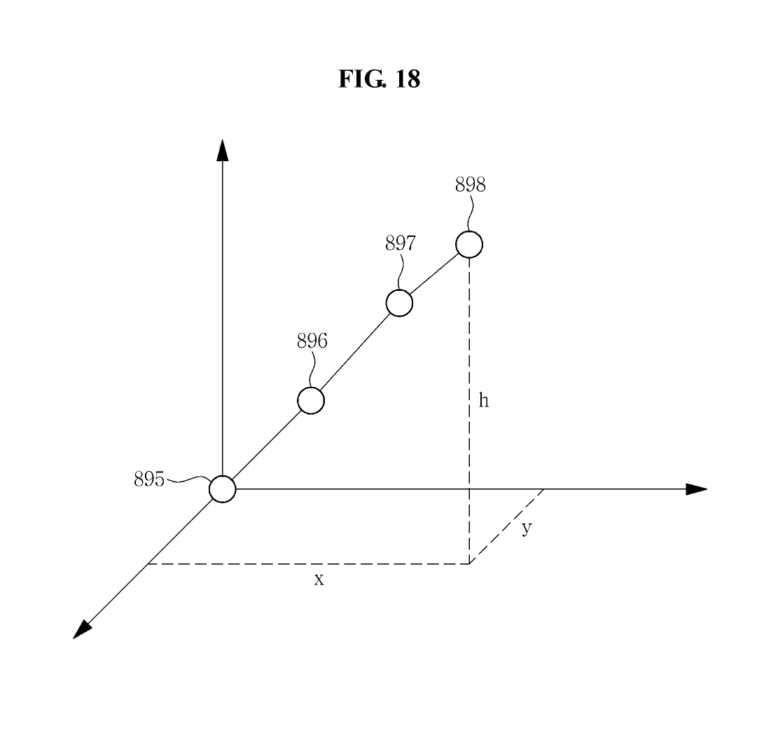

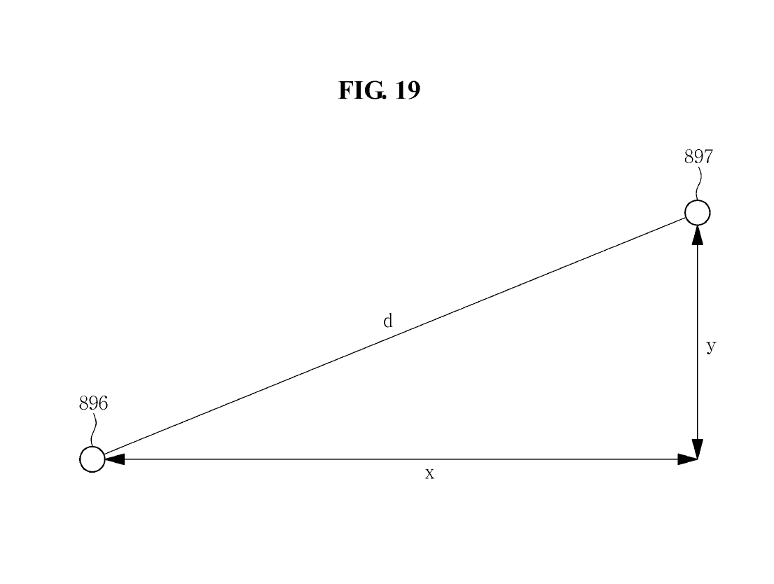

In addition, referring to FIGS. 18 and 19, the trajectory calculator 668 calculates a distance by which the ball moves for a predetermined period of time using the three-dimensional coordinates of the ball and a time difference between the plurality of images, and calculates a velocity of the ball based on the time difference and the moving distance.

That is, as described above, the coordinate converter 667 calculates respective three-dimensional coordinates of balls 895, 896, 897 and 898. The trajectory calculator 668 calculates a distance d by which the ball moves for a predetermined period of time based on the calculated three-dimensional coordinates of the balls 895, 896, 897 and 898 and the time difference between each image. Then, the trajectory calculator 668 calculates a velocity of the ball based on the time difference between each image and the moving distance d. In addition, the trajectory calculator 668 determines a result value, such as a foul, an out, a hit, a two-base hit, a three-base hit and a home run, of a struck ball based on the three-dimensional coordinates of the ball and the velocity of the ball.

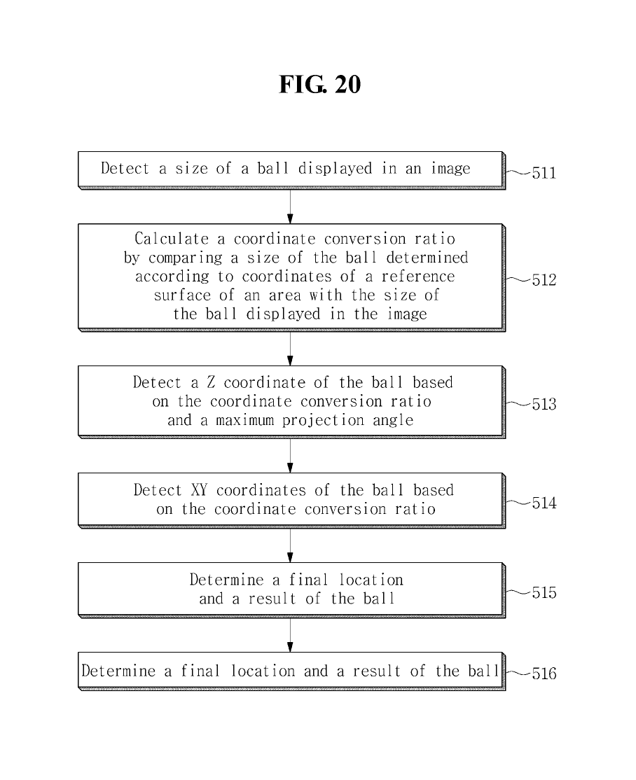

FIG. 20 is a flowchart illustrating an operation sequence of the stroke processor 666b.

Referring to FIG. 20, the baseball game system according to an exemplary embodiment detects a size of a ball displayed in an image (511). A coordinate conversion ratio is calculated by comparing a size of the ball determined according to coordinates of a reference plane of an area with the size of the ball displayed in the image (512). A Z coordinate of the ball is detected based on the coordinate conversion ratio and a maximum projection angle of a photographing unit (514). A moving distance and a velocity of the ball are calculated (515). A final location and a result of the ball are determined (516).

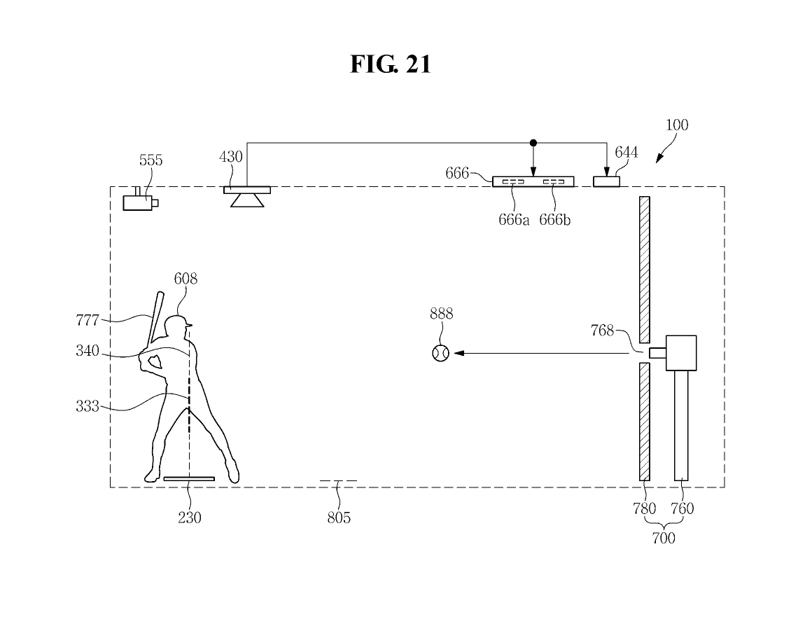

FIG. 21 is still another side view of FIG. 1 for explaining the operation of the swing determination unit 644.

The swing determination unit 644 determines whether or not a swing of a baseball bat 777 has been made based on the image photographed by the photographing unit 430. The image provided from the photographing unit 430 includes a plurality of frame images. The swing determination unit 644 may detect a degree of change in a specific portion of the image based on the plurality of frame images. For example, the swing determination unit 644 detects a batter's box where a batter 608 is positioned based on the degree of change in the image and determines whether or not a swing of the baseball bat 777 has been made based on the detected batter's box and a trajectory of an end portion of the baseball bat 777. To this end, for example, the swing determination unit 644 may binarize each frame image from the photographing unit 430 based on a corresponding photographing illuminance thereof to generate a black-white image, extract a basic contour (e.g., respective contours of the batter 608 and the baseball bat 777) of a subject (e.g., the batter 608 and the baseball bat 777) in the image by scanning the black-white image in the up-and-down direction and the left-and-right direction, determine a center position of the subject from the contour, and determine a location of the subject based on the center position. In addition, the swing determination unit 644 may detect a movement and a moving direction of the subject based on a change of the center position of the subject and from this, the degree of change in the image may be calculated.

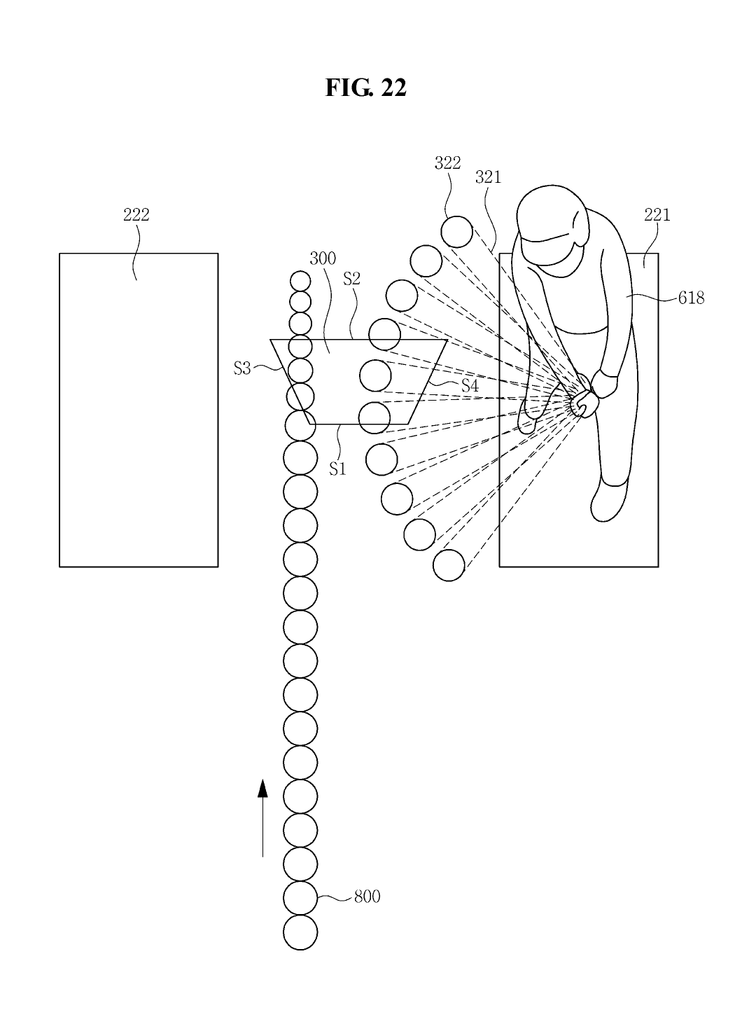

FIG. 22 is a view illustrating the image photographed by the photographing unit 430. A strike zone 300 in FIG. 22 is an image of the aforementioned strike zone 333 in FIG. 1, a first batter's box 221 in FIG. 22 is an image of the aforementioned first batter's box 241 in FIG. 1, a second batter's box 222 in FIG. 22 is an image of the aforementioned second batter's box 242 in FIG. 1, a ball 800 in FIG. 22 is an image of the aforementioned ball 888 in FIG. 1, a batter 618 in FIG. 22 is an image of the aforementioned batter 608 in FIG. 1, and a baseball bat 321 in FIG. 22 is an image of the aforementioned baseball bat 777 in FIG. 1.

The swing determination unit 644 sets the strike zone 300 based on the image photographed by the photographing unit 430. For example, the strike zone 300 may be defined as an area surrounded by four imaginary sides L1, L2, L3 and L4.

A lower side L1 and an upper side L2 face each other and a left side L3 and a right side L4 face each other. The lower side L1 and the upper side L2 may be arranged parallel to each other.

The photographing unit 430 photographs the strike zone 300 from a diagonal direction thereof rather than immediately above the strike zone 300. The strike zone 300 is shaped like a trapezoid to reflect the perspective phenomenon depending on the shooting angle. For example, the strike zone 300 may have a trapezoidal shape as illustrated in FIG. 22. Since the upper side S2 of the strike zone 300 is positioned relatively closer to the photographing unit 430 than the lower side S1 of the strike zone 300 is thereto, the upper side S2 has a longer length than the lower side S1.

The ball 800 in the image has a larger size as it approaches the photographing unit 430 due to the perspective phenomenon. That is, the size of the ball 800 in the image tells how high the ball 800 is from the ground (or the groove plate 230). In other words, a vertical location of the ball 800 may be determined from the size of the ball 800 in the image.

When a swing of the baseball bat 321 is made by the batter 618, a swing trajectory having a shape of a curve (for example, an arch) as illustrated in FIG. 3 is formed.

The operation of the swing determination unit 644 will be described in detail based on the image illustrated in FIG. 22.

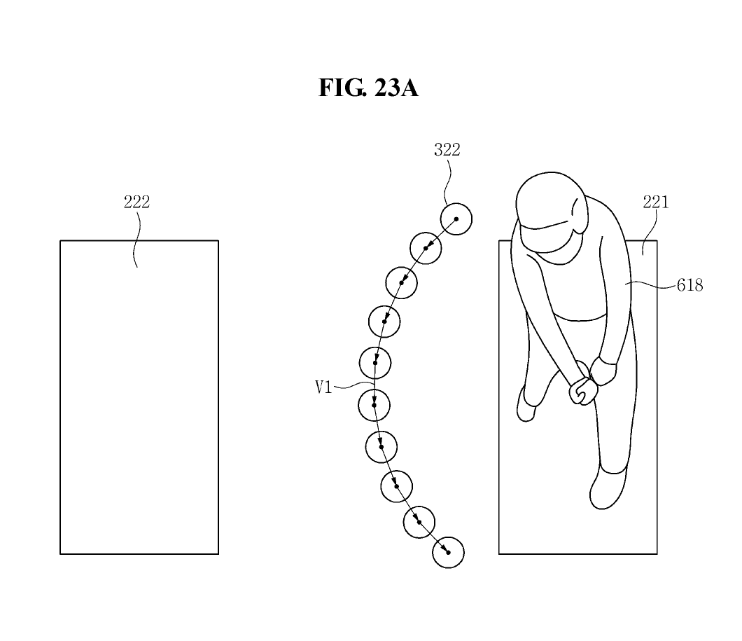

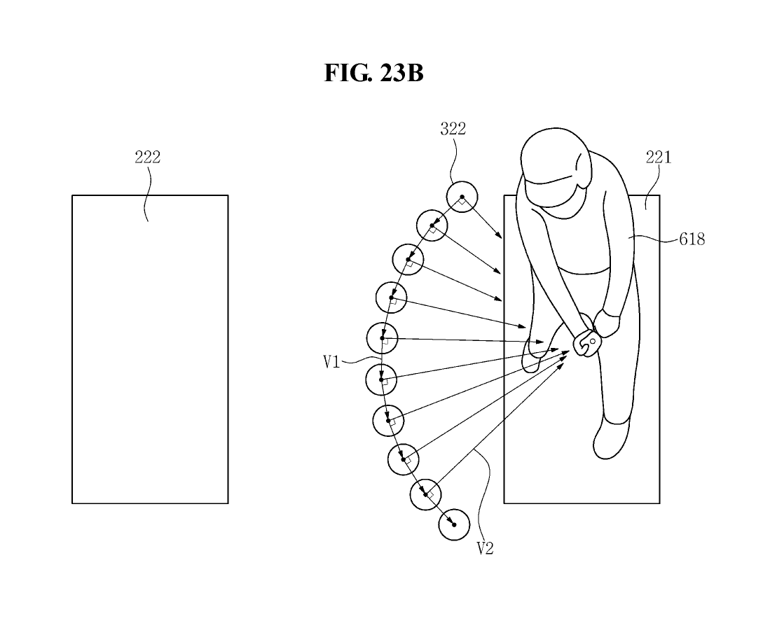

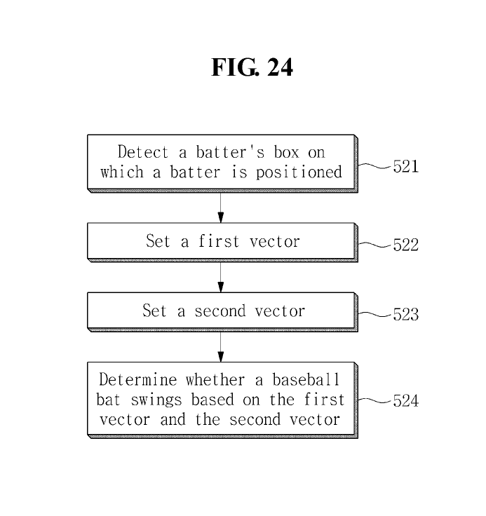

FIGS. 23A and 23B are explanatory views illustrating the operation of the swing determination unit based on the image of FIG. 22, and FIG. 24 is a flowchart illustrating an operation sequence of the swing determination unit in FIGS. 23A and 23B. In FIGS. 23A and 23B, for convenience of explanation, the first batter's box 221 and the second batter's box 222 are omitted.

First, the swing determination unit 644 detects a batter's box where the batter 618 is positioned based on the image of FIG. 22 (521). In the image illustrated in FIG. 22, a degree of change in the image at the first batter's box 221 is greater than that at the second batter's box 222. This is because the batter 618 is positioned on the first batter's box 221. Based on the difference in the degree of image change, the swing determination unit 644 determines which batter's box the batter 618 is positioned at. That is, since the degree of image change at the first batter's box 221 is greater than the degree of image change at the second batter's box 222, the swing determination unit 644 determines that the batter 618 is on the first batter's box 221. Accordingly, the first batter's box 221 is detected by the swing determination unit 644.

Subsequently, as illustrated in FIG. 23A, the swing determination unit 644 sets a first vector V1 connecting two temporally adjacent end portions 322 (end portions of the baseball bat) (522). For example, as illustrated in FIG. 23A, when fourteen end portions 322 form a single swing trajectory, thirteen first vectors V1 connecting two adjacent end portions 322 are set.

A length of the first vector V1 is proportional to a distance between the adjacent end portions 322. A direction of the first vector V1 is directed from an end portion 322 that is photographed relatively earlier in time toward an end portion 322 that is photographed later in time. For example, as illustrated in FIG. 23A, in the case where there are an (n−1)-th photographed end portion (hereinafter, “an (n−1)-th end portion”) and an n-th photographed end portion (hereinafter, “an n-th end portion”), in terms of time sequence, a first vector V1 connecting the (n−1)-th end portion and the n-th end portion has a point directed from the (n−1)-th end portion toward the n-th end portion.

Next, as illustrated in FIG. 23B, the swing determination unit 644 sets a second vector V2 extending from a center point of the first vector V1 perpendicularly to the first vector V1 (523). In such an exemplary embodiment, the swing determination unit 644 may set an extending direction of the second vector V2 based on a shape of a curve forming a swing trajectory. As an example, the swing determination unit 644—may set a line segment connecting a first end portion and a last end portion, and the second vector V2 may extend in a direction crossing the line segment. As another example, by the swing determination unit 644, the second vector V2 may extend from a convex surface of the curve toward a concave surface of the curve.

Next, the swing determination unit 644 determines whether the number of second vectors V2 that are directed toward the detected batter's box 221 or pass through the detected batter's box 221 among the second vectors V2 is within a first reference range.

Subsequently, the swing determination unit 644 determines whether an average length of the second vectors V2 is within a second reference range. The length of the second vector V2 is related to a velocity of the end portion 322 of the baseball bat, and as the length of the second vector V2 increases, it means the velocity of the end portion 322 is faster.

The swing determination unit 644 determines whether or not a swing of the baseball bat 777 has been made based on the two determinations (524). For example, in the case where the number of second vectors V2 that are directed toward the detected batter's box 221 or pass through the detected batter's box 221 among the second vectors V2 is within the first reference range and the average length of the second vectors V2 is within the second reference range, the swing determination unit 644 determines that a swing of the baseball bat 321 has been made.

On the other hand, in the case where the number of second vectors V2 that are directed toward the detected batter's box 221 or pass through the detected batter's box 221 among the second vectors V2 is out of the first reference range, or the average length of the second vectors V2 is out of the second reference range, the swing determination unit 644 determines that the end portions 322 forming such a trajectory are noise. That is, in such an exemplary embodiment, the swing determination unit 644 determines that a swing of the baseball bat 321 has not been made.

As such, the swing determination unit 644 determines whether or not a swing of the baseball bat 777 has been made based on the trajectory and velocity of the end portions 322.

In an exemplary embodiment, the swing determination unit 644 may further determine lengths of the first vectors V1 to detect a check swing. For example, the swing determination unit 644 may further determine whether a sum of lengths of the first vectors V1 is within a third reference range. In such an exemplary embodiment, in the case where the number of second vectors V2 that are directed toward the detected batter's box 221 or pass through the detected batter's box 221 among the second vectors V2 is within the first reference range, the average length of the second vectors V2 is within the second reference range, and the sum of the lengths of the first vectors V1 is within the third reference range, the swing determination unit 644 determines that a swing of the baseball bat 321 has been made.

The first and second vectors V1 and V2 in FIGS. 22, 23A and 23B have characteristics coinciding with the first, second and third reference ranges, and in such an exemplary embodiment, the swing determination unit 644 determines that a swing of the baseball bat 321 has been made.

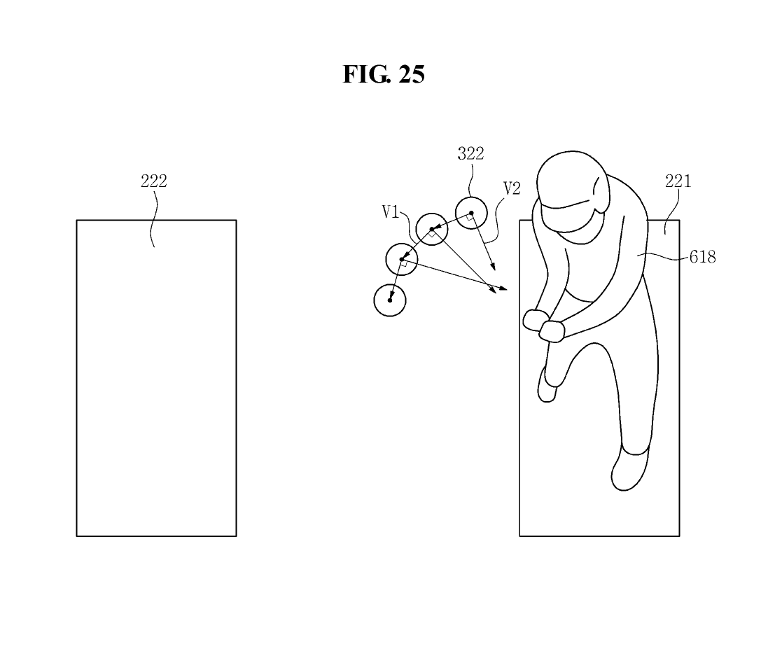

FIG. 25 is a view illustrating a trajectory of a baseball bat in the case of a check swing.

As illustrated in FIG. 25, in the case where the baseball bat 321 is not swung properly, the swing determination unit 644 determines it as a check swing. That is, it is not determined as a swing by the swing determination unit 644.

The sum of the lengths of the first vectors V1 in FIG. 25 is out of the third reference range. For example, in the case where the sum of the lengths of the first vectors V1 is less than a predetermined threshold value, the swing determination unit 644 may determine it as a check swing.

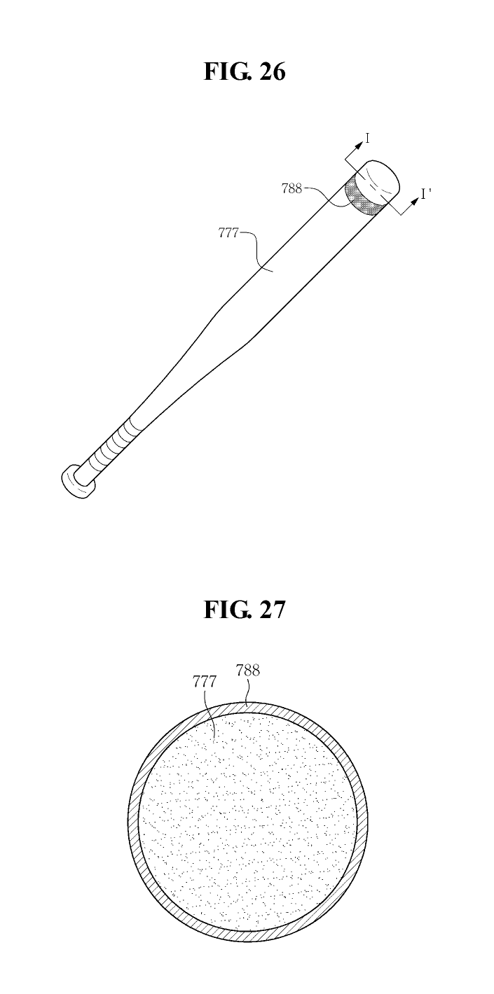

FIG. 26 is a perspective view illustrating a baseball bat used in the baseball game system of FIG. 1, and FIG. 27 is a cross-sectional view taken along line I-I′ of FIG. 1.

In order to substantially minimize the effect of noise, the baseball bat 777 may further include a marking pattern 788, as illustrated in FIGS. 26 and 27.

As illustrated in FIG. 26, the marking pattern 788 may be positioned at an end portion of the baseball bat 777.

As illustrated in FIG. 27, the marking pattern 788 may have a shape surrounding the end portion of the baseball bat 777.

The marking pattern 788 may have a bright color so that the end portion of the baseball bat 777 may be clearly visible when generating the black-white image as descried above. For example, the marking pattern 788 may have a lighter color than a color of the baseball bat 777.

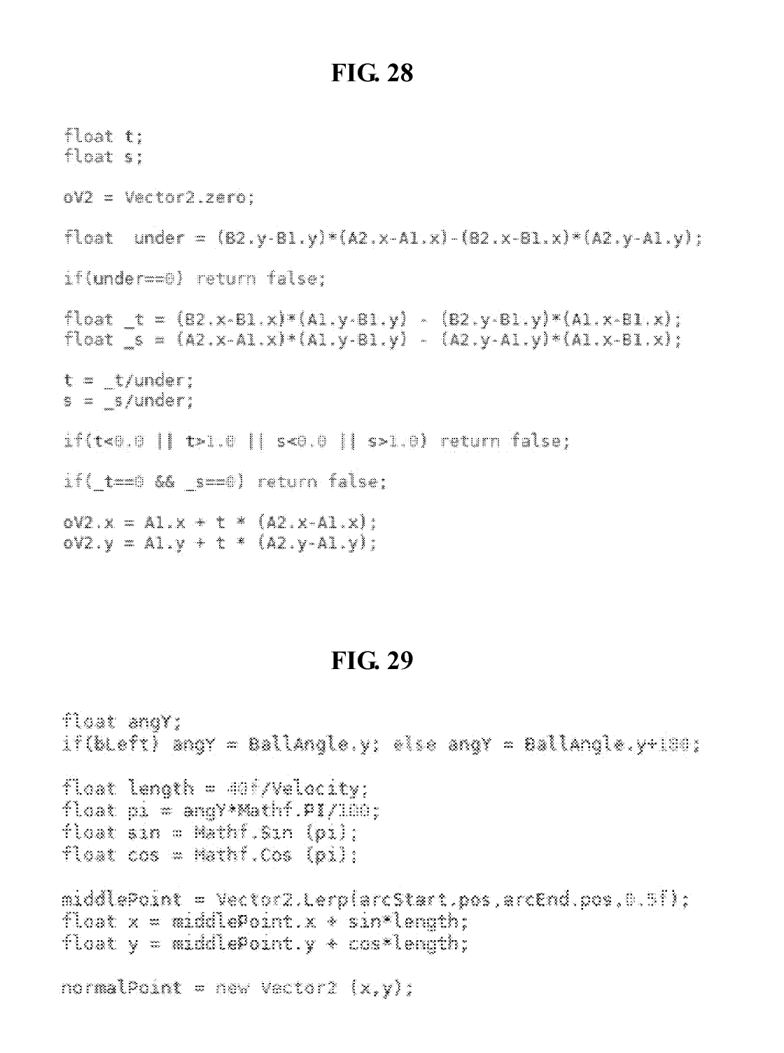

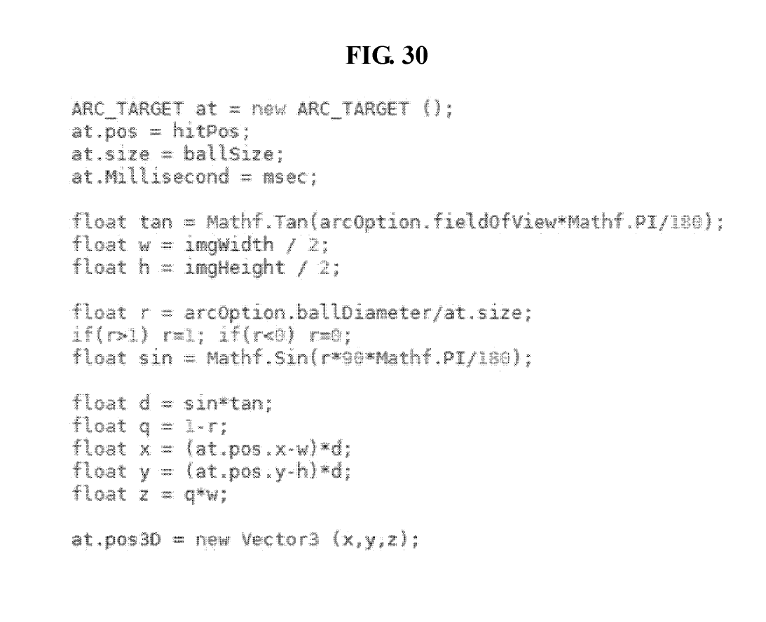

FIG. 28 is a view illustrating an algorithm applied to the non-stroke processor, FIG. 29 is a view illustrating an algorithm applied to the stroke processor, and FIG. 30 is a view illustrating an algorithm applied to the swing determination unit.

The non-stroke processor may detect the coordinates of the ball in the determination area through the algorithm of FIG. 28, the stroke processor may detect the coordinates of the struck ball through the algorithm illustrated in FIG. 29 or the algorithm described above (the algorithm for obtaining the three-dimensional coordinates), and the swing determination unit may determination whether or not a swing has been made through the algorithm of FIG. 30.

As set forth hereinabove, the baseball game system according to one or more exemplary embodiments may provide the following effects.

First, the baseball game system may accurately determine the location of the ball using a single camera by determining the height of the ball based on the size of the ball.

Second, the baseball game system may accurately determine whether or not the game is a strike by setting the strike zone in a trapezoidal shape in consideration of the photographing angle of the camera.

Third, the baseball game system may even predict the location of a struck ball in the determination area based on the trajectory of the ball before the striking.

Fourth, the baseball game system may determine the location of the ball in the determination area more accurately by correcting the average size based on at least one of the degree of size change of the balls before striking and the size change trend of the balls.

Fifth, the baseball game system may accurately determine the location of the ball by determining the location of the ball in consideration of the maximum projection angle of the camera.

Sixth, the baseball game system may accurately determine whether a swing of a baseball bat has been made in consideration of the position of a batter, the swing trajectory and velocity of the baseball bat, or the like.

Seventh, the baseball game system may determine whether a swing of the baseball bat has been made more accurately by determining whether a check swing has been made based on the length of the swing trajectory.

Eighth, the baseball game system may detect the trajectory of the baseball bat more accurately by using the baseball bat including a marking pattern.

While the present invention has been illustrated and described with reference to the exemplary embodiments thereof, it will be apparent to those of ordinary skill in the art that various changes in form and detail may be made thereto without departing from the spirit and scope of the present invention.

What is claimed is:

1. A baseball game system comprising:
a pitching unit pitching a ball toward a determination area comprising a strike zone;
a photographing unit positioned in a space between the determination area and the pitching unit; and
a location detector detecting a location of a ball based on a plurality of images from the photographing unit,
wherein the location detector comprises a non-stroke processor detecting a location of a non-struck ball and a stroke processor detecting a location of a struck ball,
the non-stroke processor sets first, second, third and fourth straight lines defining the strike zone; calculates, when the ball in the image passes between the first straight line and the second straight line, an average size of the balls between the first straight line and the second straight line; and detects a vertical location of the ball in the determination area based on the average size.

2. The baseball game system as claimed in claim 1, wherein the strike zone defined by the first, second, third and fourth straight lines has a trapezoidal shape.

3. The baseball game system as claimed in claim 1, wherein the non-stroke processor detects the vertical location of the ball in the determination area by comparing the average size with a predetermined reference value.

4. The baseball game system as claimed in claim 3, wherein the reference value comprises a lower limit value defining a size of the ball located at a lower side of the strike zone; and
an upper limit value defining a size of the ball located at an upper side of the strike zone.

5. The baseball game system as claimed in claim 3, wherein the non-stroke processor calculates coordinates of a first point representing a vertical location of the ball on the third straight line based on the comparison between the average size and the reference value;
calculates coordinates of a second point representing a vertical location of the ball on the fourth straight line based on the comparison between the average size and the reference value; and
sets a fifth straight line passing through the first point and the second point.

6. The baseball game system as claimed in claim 5, wherein the non-stroke processor sets a sixth straight line based on a trajectory of the ball, and
calculates a horizontal location of the ball in the determination area based on coordinates of a point at which the sixth straight line meets the fifth straight line.

7. The baseball game system as claimed in claim 1, wherein the non-stroke processor sets a size of the ball closest to the first straight line as the average size when the ball in the image does not pass between the first straight line and the second straight line.

8. The baseball game system as claimed in claim 7, wherein the non-stroke processor estimates the average size of the balls between the first straight line and the second straight line based on at least one of a degree of size change of the ball approaching the first straight line and a distance between the first straight line and the ball closest to the first straight line.

9. The baseball game system as claimed in claim 4, wherein the non-stroke processor adjusts the upper limit value, the lower limit value and a height of the strike zone based on a height of a batter.

10. The baseball game system as claimed in claim 9, further comprising a height input unit for inputting the height of the batter.

11. The baseball game system as claimed in claim 10, wherein the non-stroke processor adjusts the upper limit value, the lower limit value and the height of the strike zone based on the height input to the height input unit.

12. The baseball game system as claimed in claim 9, further comprising a human body sensor positioned on batter's boxes defining the determination area, the human body sensor determining presence of a batter and detecting a height of the batter.

13. The baseball game system as claimed in claim 1, wherein the stroke processor comprises a stroke coordinate converter calculating three-dimensional coordinates of the ball based on: a ball size determined, from one of the plurality of images, according to coordinates of a reference plane of a maximum projection angle area defined by a maximum projection angle of the photographing unit; a size of the ball displayed in the image; XY coordinates of the ball displayed in the image; and the maximum projection angle of the photographing unit.

14. The baseball game system as claimed in claim 13, wherein the coordinate converter comprises a ratio calculator calculating a coordinate conversion ratio by dividing the size of the ball displayed in the image by the ball size determined according to the coordinates of the reference plane of the maximum projection angle area.

15. The baseball game system as claimed in claim 14, wherein the coordinate converter further comprises a coordinate calculator calculating a Z coordinate of the ball by dividing a value obtained by multiplying the coordinate conversion ratio and a length of one side of the reference plane of the maximum projection angle area by a tangent value corresponding to the maximum projection angle of the photographing unit.

16. The baseball game system as claimed in claim 15, wherein the coordinate calculator calculates the XY coordinates of the ball by multiplying the coordinate conversion ratio and the XY coordinates of the ball displayed in the image.

17. The baseball game system as claimed in claim 13, wherein the stroke processor further comprises a trajectory calculator calculating a final location of the ball by analyzing the plurality of images.

18. The baseball game system as claimed in claim 17, wherein the trajectory calculator calculates a distance by which the ball moves for a predetermined time based on the three-dimensional coordinates of the ball and a time difference between the plurality of images and calculates a velocity of the ball based on the time difference and the moving distance.

19. The baseball game system as claimed in claim 18, wherein the trajectory calculator determines a result value, such as a foul, an out, a hit, a two-base hit, a three-base hit and a home run, of a struck ball based on the three-dimensional coordinates of the ball and the velocity of the ball.

20. The baseball game system as claimed in claim 1, further comprising a swing determination unit determining whether or not a batter on one of batter's boxes on opposite sides of the strike zone has swung a baseball bat based on the image from the photographing unit,
wherein the swing determination unit detects a batter's box on which the batter is positioned based on a degree of change in the image and determines whether or not a swing of the baseball bat has been made based on the detected batter's box and a trajectory of an end portion of the baseball bat.

21. The baseball game system as claimed in claim 20, wherein the swing determination unit sets a first vector connecting two temporally adjacent end portions and sets a second vector perpendicular to the first vector,
determines whether the number of second vectors toward the detected batter's box among the second vectors is within a first reference range, and
determines whether an average length of the second vectors is within a second reference range so as to determine whether or not a swing of the baseball bat has been made.

22. The baseball game system as claimed in claim 21, wherein the swing determination unit determines that a swing of the baseball bat has been made when the number of second vectors toward the detected batter's box among the second vectors is within the first reference range and the average length of the second vectors is within the second reference range.

23. The baseball game system as claimed in claim 21, wherein the swing determination unit further determines whether a sum of lengths of the first vectors is within a third reference range.

24. The baseball game system as claimed in claim 23, wherein the swing determination unit determines that a swing of the baseball bat has been made when the number of second vectors toward the detected batter's box among the second vectors is within the first reference range, the average length of the second vectors is within the second reference range, and the sum of the lengths of the first vectors is within the third reference range.

25. The baseball game system as claimed in claim 20, wherein the baseball bat further comprises a marking pattern.

26. The baseball game system as claimed in claim 25, wherein the marking pattern is positioned at an end portion of the baseball bat.

27. The baseball game system as claimed in claim 26, wherein the marking pattern surrounds the end portion.

28. The baseball game system as claimed in claim 25, wherein the marking pattern has a lighter color than a color of the baseball bat.

29. The baseball game system as claimed in claim 20, further comprising a determination unit determining a ball and a strike based on the determination result from the swing determination unit and the detection result from the non-stroke processor.
